(19) United States
(12) Patent Application Publication
(10) Pub. No.: US 2011/0204598 A1
(43) Pub. Date: Aug. 25, 2011

(54) Folding Wagon

(76) Inventor: Mark Stevenson, Lombard, IL (US)

(21) Appl. No.: 12/711,745

(22) Filed: Feb. 24, 2010

(51) Int. Cl. B62B 3/02

(52) U.S. Cl. 280/639

(57) ABSTRACT

A folding wagon is provided having a frame with cross-member pairs that open and close in a scissor-like motion. The cross-members are connected to tower members at the corners by joints. Upper ends of the cross-members connect to slider joints that are movable along the length of the tower members. A cargo area is attached to the frame. The wagon is configurable between a collapsed position and a deployed or expanded position.

### FIELD OF THE INVENTION

The present invention relates to carriers, more specifically folding wagons.

### BACKGROUND OF THE INVENTION

Carriers such as wagons are frequently used for storage and transportation. These wagons can carry and move all sorts of items, and many times these wagons are sized and fitted so that an adult may transport a child or children with them while traveling on foot. These wagons usually have a body section fastened onto a number of wheels and attached to a handle for convenient towing. The body section includes a cargo area and sides acting as guard rails. The body section may be made out of solid metal, wood, plastic, or other material and often forms a cargo area that is substantially rectangular in shape.

While these wagons provide transportation of other entities, the transportation of the wagons themselves can be difficult due to their shapes, sizes, and weights. If, for example, a wagon is to be used for short range recreational travel at the destination of a long distance car trip, the wagon must be transported in the car for the long journey. Depending on the size of the car, the wagon may take up much of the trunk space, cabin space, or may not fit at all. Also, if the wagon must ever be carried or lifted by hand, it would likely be a multiple person job. The weight, let alone the shape and size, would make it very difficult for one person to transport unaided.

Folding, or “collapsible” cart have been designed, such as that described is U.S. Pat. No. 6,491,318. To form the cargo area, the '318 patent describes attaching a bag to the top corners of the framework of cross-members. The bag then hangs freely down into the body of the wagon, forming the cargo area. For additional support, a support panel is attached to, and stretches between, the bottom corners of the framework of cross-members. This support panel provides additional support and a bottom boundary for the stretchable bag.

However, the cart of the '318 patent and other prior carts and wagons may not offer the maximum amount of control, consistency, and efficiency to the wagon folding/collapsing process due to unruly, partially-attached fabrics being condensed into a small area. For example, in U.S. Pat. No. 6,491,318, the bag is only attached to the framework at the bag's open end. When the wagon is closed, the bottom of the bag opposite the open end is left to hang free and interact with the framework as it may. This could potentially lead to interference with the collapsing process by the free end of the bag if the free end of the bag gets tangled with, or in the way of, the cross-members.

Also, the bag provided in the '318 patent may not assure a secure, controlled, uniform cargo area because it is attached on only one end. Due to the unattached nature of the bottom of the bag, the shape of the cargo area is a varying entity. If something heavy is located in the middle of the bag, then the bottom of the bag, and hence the floor of the cargo area, will be sloped down toward the center. Similarly, something inside the bag that is stationary with respect to the bottom of the bag may still move with respect to the wagon if the bag slides or swings with respect to the wagon.

Furthermore, these prior collapsible wagon designs may require the cargo area be formed of more than one piece with separate support panel. This would increase the weight and complexity of the wagon, as well as the amount of materials to be folded during the collapsing of the wagon.

The present inventor has recognized the need for a folding wagon that allows for a consistent and efficient collapsing process. The present inventor has recognized the need for a folding wagon that provides a secure, controlled, and predictable cargo area. The present inventor has further recognized the need for a folding wagon that minimizes the amount of comprised components.

### SUMMARY OF THE INVENTION

The present invention comprises a folding wagon with tower members. The wagon includes a framework, a cargo area supported on the framework, wheels attached to the bottom of the framework, and a handle with which to pull the wagon.

The framework comprises a series of pairs of cross-members that are crossed and joined at an intermediate location along the cross-members. When the wagon is collapsed, each pair of cross-members closes in a scissor-like motion so that the upper ends of the cross-members in each pair move closer together. This compresses and greatly reduces both the length and width of the wagon. When the wagon is deployed or expanded, the upper ends of the cross-members are further apart. When the wagon is opened fully, its length and width reach their maximum and the cross-members are in their maximum deployed position

A number of tower members are located at the intersections of pairs of cross-members in the series. The tower members provide guides for the ends of each cross-member in each pair adjacent to the support. As the wagon is collapsed, the ends of the top cross-members on each support move upward toward the top end of the support and away from the ends of the bottom cross-members. As the wagon is deployed, the ends of the top cross-members on each support move downward toward the bottom end of the support and toward the ends of the bottom cross-members. On each tower, attached to or above the ends of the top cross-members, is located a slider joint, that may also act as a support for the bottom of the cargo area.

The basket of the cargo area is attached to a top end of each the towers located at the corners. A bottom edge of the basket is connected to a frame that is slidably mounted to the towers and located above the slider joints. When the slider joint is moved up the tower, the fabric basket is condensed as the framework is collected together. When the slider is moved down the tower, the basket falls toward its opened position.

Wheels are attached to the frame of the wagon and can be folded up along with the rest of the wagon. An extendable handle is also attached to the framework of the wagon at one end.

Numerous other advantages and features of the present invention will become readily apparent from the following detailed description of the invention and the embodiments thereof, and from the accompanying drawings.

### BRIEF DESCRIPTION OF THE DRAWINGS

FIG. 1 is a side perspective view of a first embodiment of the wagon present invention with cargo area removed;

FIG. 2 is a side perspective view of the wagon of FIG. 1;

FIG. 3 is a top view of the wagon of FIG. 1;

FIG. 4 is a front perspective view of the wagon of FIG. 1;

FIG. 5 is a rear perspective view of the wagon of FIG. 1;

FIG. 6 is a top view of the wagon of FIG. 1;

FIG. 6A is a side perspective view of the wagon of FIG. 1 in a collapsed position;

FIG. 7 is a bottom perspective view of the slider joint arrangement of the wagon of FIG. 1;

FIG. 8 is a perspective view of the slider joint of FIG. 7;

FIG. 9 is a bottom perspective view of the arrangement of FIG. 7 with the slider joint removed;

FIG. 10 is a top perspective view of the fixed joint arrangement of the wagon of FIG. 1;

FIG. 11 is a perspective view of the fixed joint of FIG. 10;

FIG. 12 is a top perspective view of the arrangement of FIG. 10 with the fixed joint removed;

FIG. 13 is a top perspective view of the upper middle support joint arrangement of the wagon of FIG. 1;

FIG. 14 is a perspective view of the upper middle support joint of FIG. 13;

FIG. 15 is a top perspective view of the arrangement of FIG. 13 with the upper middle support joint removed;

FIG. 16 is a side perspective view of the wagon of FIG. 1 with the cargo area included;

FIG. 17 is a side perspective view of a second embodiment of the wagon of the present invention with the cargo area removed;

FIG. 18 is a front perspective view of the wagon of FIG. 17;

FIG. 19 is a rear perspective view of the wagon of FIG. 17;

FIG. 20 is a top view of the wagon of FIG. 17;

FIG. 21 is a perspective view of a corner slider joint arrangement of the wagon of FIG. 17;

FIG. 22 is a bottom perspective view of the arrangement of FIG. 21;

FIG. 23 is a perspective view of the corner slider joint of the arrangement of FIG. 21;

FIG. 24 is a perspective view of the arrangement of FIG. 21 with the corner slider joint removed;

FIG. 25 is a top perspective view of a corner fixed joint arrangement of the wagon of FIG. 17;

FIG. 26 is a perspective view of the corner fixed joint of the arrangement of FIG. 25;

FIG. 27 is a top perspective view of the arrangement of FIG. 25 with the corner fixed joint removed;

FIG. 28 is a perspective view of a side slider joint arrangement of the wagon of FIG. 1;

FIG. 29 is a bottom perspective view of the arrangement of FIG. 28;

FIG. 30 is a perspective view of the side slider joint of the arrangement of FIG. 28;

FIG. 31 is a perspective view of the arrangement of FIG. 28 with the side slider joint removed; and

FIG. 32 is a side perspective view of the wagon of FIG. 17 with the cargo area included.

FIG. 33 is a side perspective view of an alternate embodiment of the wagon.

FIG. 34 is a side view of the wagon of FIG. 33.

FIG. 35 is a side perspective view of the wagon of FIG. 33 in a collapsed position.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

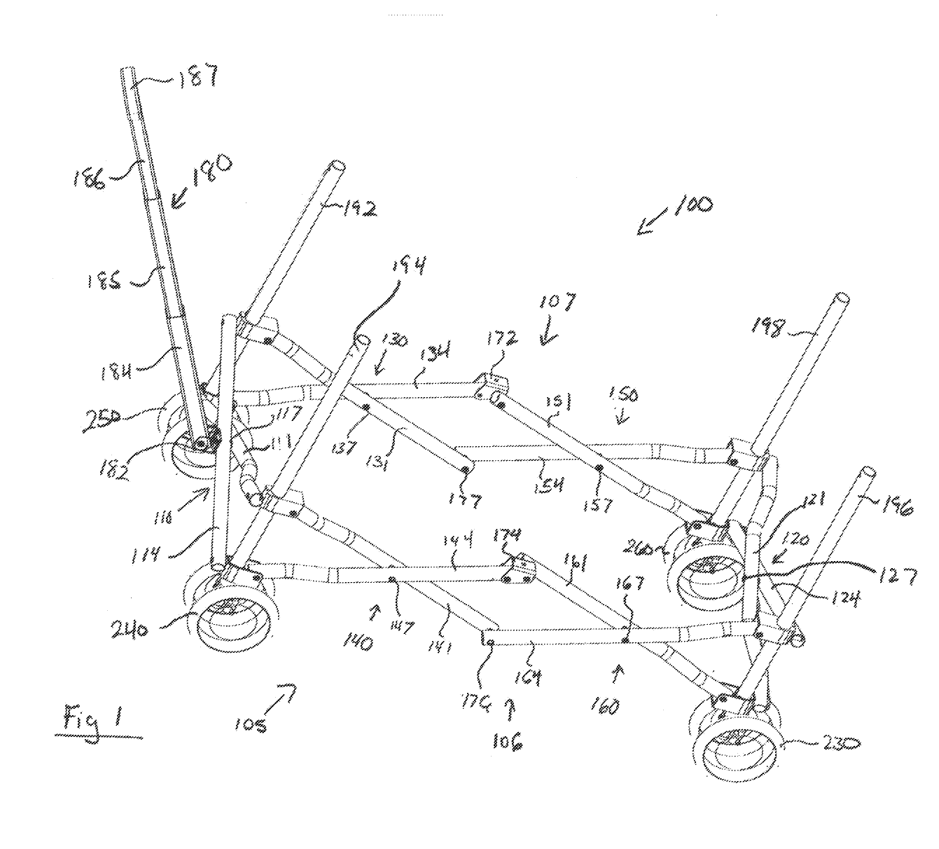

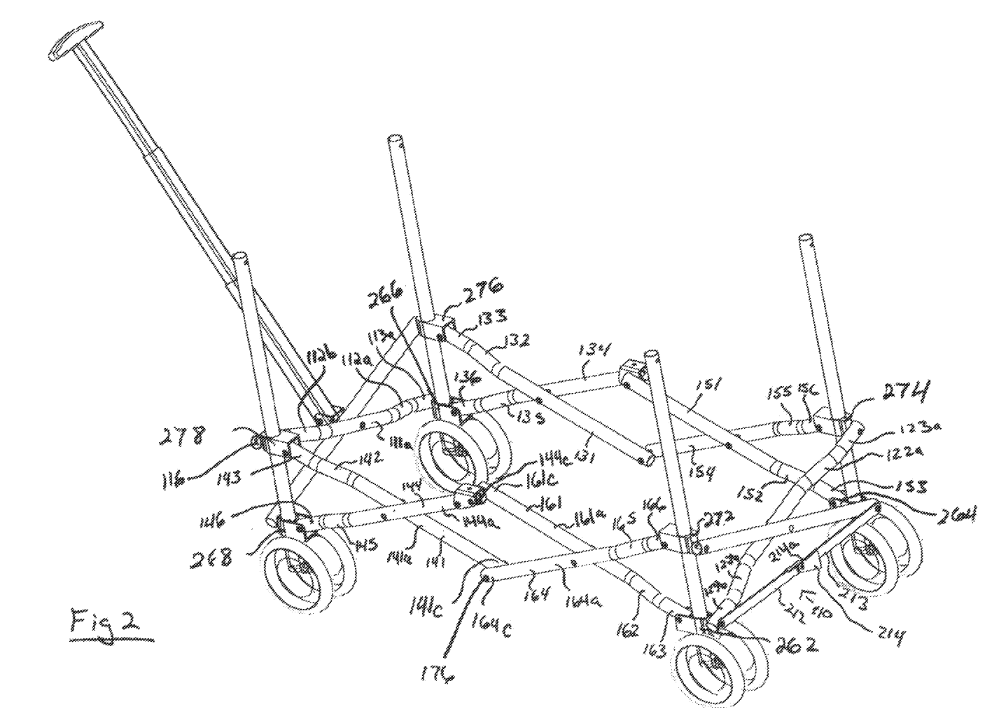

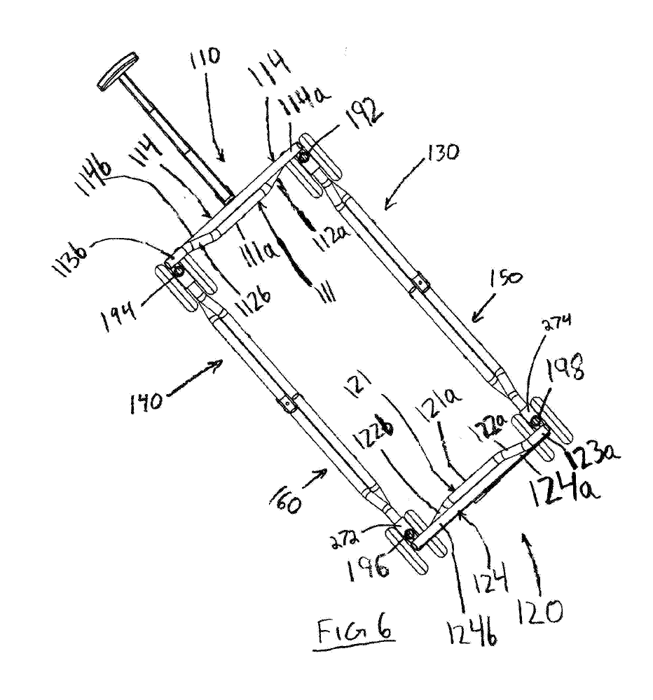

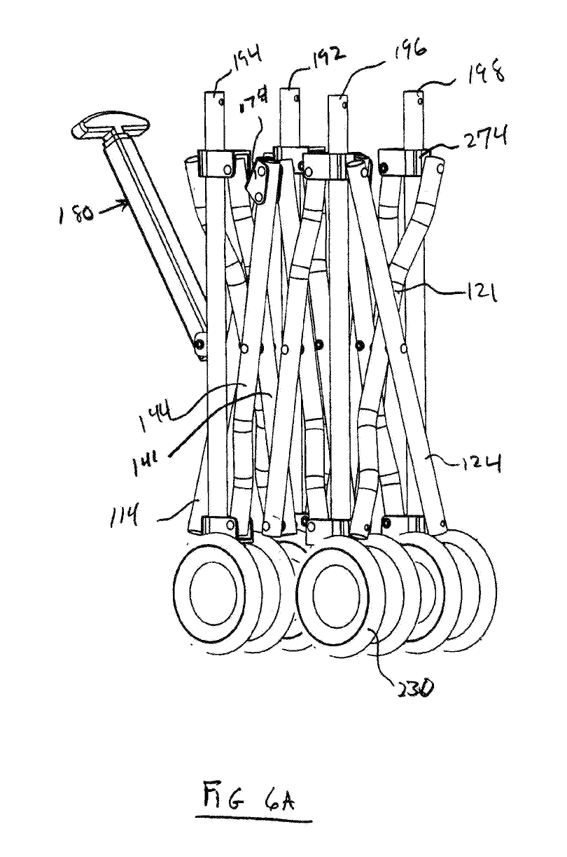

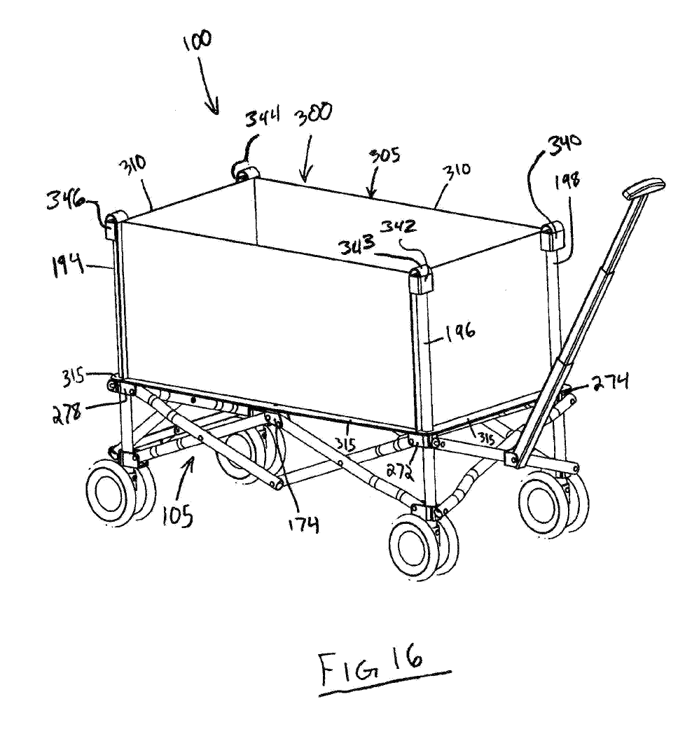

FIGS. 1-6 show the wagon 100 without the cargo area 300. The wagon has a expanded or deployed position as shown in at least FIG. 1 and FIG. 16, and a collapsed position as shown in FIG. 6A. The frame is extended in two horizontal directions or in all three directions, depending on the rotational pivot location when the wagon is in the expanded position. The wagon 100 has a framework 105. The framework 105 comprises a front cross-member pair 110, a back cross-member pair 120, a first forward side cross-member pair 140, a first rear side cross-member pair 160, a second forward side cross-member pair 130, a second rear side cross-member pair 150, four tower members 192, 194, 196, 198, four slider joints 272, 274, 276, 278, four fixed joints 262, 264, 266, 268, and upper middle support joints 172, 174. The fixed joints are fixed in that they do not slide on the telescopic supports during deployment and collapse of the wagon, however fixed joins allow cross-members to pivot about a connection point with the fixed joint. The wagon 100 has two front wheels 240, 250 operatively connected to front bottom corners of the framework 105, and two rear wheels 230, 260 operatively connected to rear bottom corners of the framework 105. At least the front wheels being pivotable for steering the wagon. The cross-members can be made of hollow tube to provide a lightweight and strong frame. The scissoring members extend in a vertical direction when the wagon is in a collapsed position. The wheels may be large and/or soft for ease of movement on a variety of surfaces.

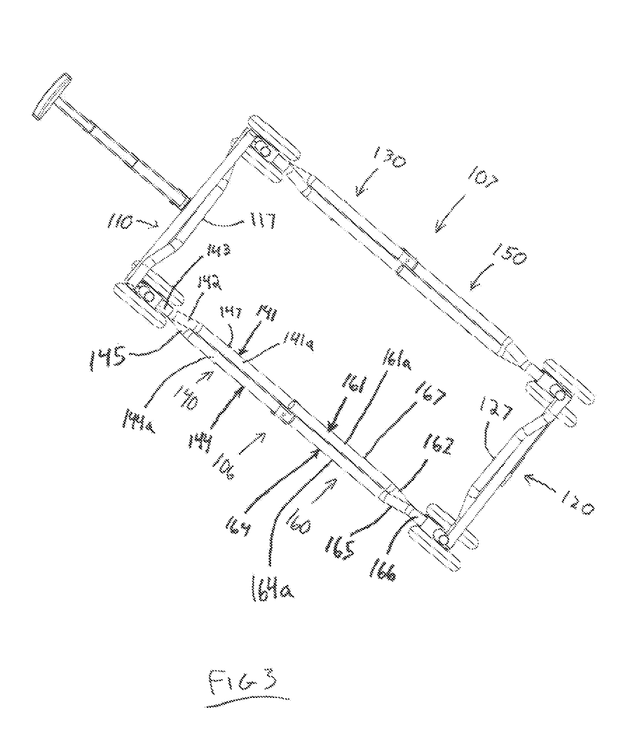

Each cross-member pair is joined at each end of the cross-member pair to an adjacent cross-member pair in the series of cross-member pairs, which forms the perimeter of the framework 105. The first forward side cross-member pair 140 and the first rear side cross-member pair 160 comprise a first side 106 of the framework 105. The second forward side cross-member pair 130 and the second rear side cross-member pair 150 comprise an opposite second side 107 of the framework. The first 106 and second 107 sides of the frame work 105 are connected and spaced apart by the front cross-member pair 110 and the back cross-member pair 120. Each cross member pair comprises a two cross-member connected at an intermediate pivot location, and each cross-member of a cross-member pair is movable above the pivot location relative to the other cross-member in a scissoring motion. A top view of the wagon, such as that in FIG. 3, shows that intermediate portions of the cross-members of a cross-member pair are positioned side-by-side to each other.

The first side 106 of the framework 105 will be described. It is understood that the second side 107 of the framework 105 is mirror image identical to the first side 106 across a vertical mid-plane defined by pivot joints 117, 127 of the front 110 and rear 120 cross-member pairs. The first forward side cross-member pair 140 comprises an inner cross-member 141 and an outer cross-member 144 connected at pivot point 147. The inner cross-member 141 has a front end 143 that is outwardly offset from the main portion 141a by an outward angled portion 142. The outer cross-member 144 has a front end 146 that is inwardly offset from the main portion 144a by an inward angled portion 145. The first rear side cross-member pair 160 has an inner cross-member 161 and an outer cross-member 164 connected at a pivot point 167. The inner cross-member 161 has an end 163 that is outwardly offset from the main portion 161a by an outward angled portion 162. The outer cross-member 164 has a rear end 166 that is inwardly offset from the main portion 164a by an inward angled portion 165. The pivot points 147, 167 may be located at an intermediate location along the length of each cross-member 141, 144 and 161, 164, respectively. Alternatively the pivot points 147, 167 may be located at a non-midpoint location along the length of each cross-member.

The front ends 143, 146 of the cross-members 141, 144 are opposite rear ends 144c, 141c, respectively. The front ends 164c, 161c of the cross-members 161, 164 are opposite rear ends 163, 166, respectively. A lower middle joint 176 connects the rear end 141c of cross-member 141 to the front end 164c of cross-member 164. The rear end 144c of cross-member 144 connects at the upper middle support joint 174 to the front end 161c of cross-member 161. The inside surface of cross-member 164 faces the outside surface of cross-member 141 at the lower middle joint 176. The inside surface of cross-member 144 faces the outside surface of cross-member 161 at the upper middle support joints 174. The front end 143 of cross-member 141 connects to slider joint 278, located slidably on tower member 194. The front end 146 of cross-member 144 connects to fixed joint 268, located on a bottom portion of the tower member 194. The rear end 166 of cross-member 164 connects to slider joint 272, located slidably on tower member 196. The rear end 163 of cross-member 161 connects to fixed joint 262, located on a bottom portion of the tower member 196. The rear ends 166, 163 of the first rear side cross-member pair 160 are offset in opposite directions. The front ends 143, 146 of the first front side cross-member pair 140 are offset in opposite directions.

The first forward side cross-member pair 140 and the first rear side cross-member pair 160 form two X-shaped sections. The X-shaped section of the first forward side cross-member pair 140 opens and closes to deploy and collapse, respectively, the wagon 100. To deploy the wagon 100, cross-member 144 is rotated in a clockwise direction about pivot point 147 as cross-member 141 is rotated counterclockwise about pivot point 147, as viewed from the outside of the wagon 100. When this occurs, slider joint 278 slides downward on tower member 194 and toward fixed joint 268. Similarly, support joint 174 moves downward and toward lower middle joint 176. To collapse the wagon 100 to a position as shown in FIG. 6A, cross-member 144 is rotated in a counterclockwise direction about pivot point 147 as cross-member 141 is rotated clockwise about pivot point 147, as viewed from the outside of the wagon 100. When this occurs, slider joint 278 slides upward on tower member 194 and away from fixed joint 268. Similarly, support joint 174 moves upward and away from lower middle joint 176. The upward motion of the slider joint 278 as connected to the cross-member 141 draws the telescopic support 194 inward toward a center of the wagon.

The X-shaped section of the first rear side cross-member pair 160 opens and closes to deploy and collapse, respectively, the wagon 100. To deploy the wagon 100, cross-member 164 is rotated in a clockwise direction about pivot point 167 as cross-member 161 is rotated counterclockwise about pivot point 167, as viewed from the outside of the wagon 100. When this occurs, slider joint 272 slides downward on tower member 196 and toward fixed joint 262. Similarly, support joint 174 moves downward and toward lower middle joint 176. To collapse the wagon 100, cross-member 164 is rotated in a counterclockwise direction about pivot point 167 as cross-member 161 is rotated clockwise about pivot point 167, as viewed from the outside of the wagon 100. When this occurs, slider joint 272 slides upward on tower member 196 and away from fixed joint 262. Similarly, support joint 174 moves upward and away from lower middle joint 176.

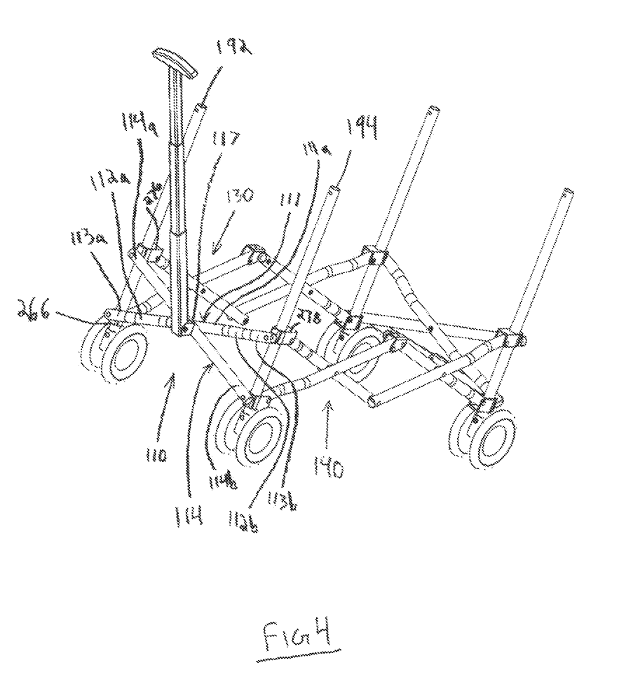

FIGS. 4 and 6 show the front cross-member pair 110, which connects first forward side cross-member pair 140 and second forward side cross-member pair 130. Front cross-member pair 110 comprises an inner cross-member 111 and an outer cross-member 114 connected at pivot point 117. The inner cross-member 111 has a first end 113a and a second end 113b that are outwardly offset from the main portion 111a by outward angled portions 112a and 112b, respectively. The pivot point 117 may be located at an intermediate location along the length of the cross-members 111, 114.

Alternatively, the pivot point 117 may be located at a non-midpoint location along the length of the cross-members 111, 114. If the pivot point 117 is located at a non-midpoint location along the length of the cross-members, the wagon will fold in three directions. When the wagon is expanded the vertical towers will face outward from the wagon center. This adds stability to the wagon assembly when a child sits in the fabric basket. Outer cross-member 114 is straight along its length and has right and second ends 114a and 114b, respectively.

The first ends 113a, 114a of the cross-members 111 and 114 are opposite second ends 114b, 113b, respectively. The first end 113a of cross-member 111 is connected to fixed joint 266, located on a bottom portion of the tower member 192. The second end 113b of cross-member 111 is connected to slider joint 278, located slidably on tower member 194. The first end 114a of cross-member 114 is connected to slider joint 276, located slidably on tower member 192. The second end 114b of cross-member 114 is connected to fixed joint 268, located on a bottom portion of tower member 194. The inner surfaces of cross-members 111, 114 face the outer surfaces of slider joints 276, 278, fixed joints 266, 268, and tower members 192, 194.

The front cross-member pair 110 forms an X-shaped section. The X-shaped section of the front cross-member pair 110 opens and closes to deploy and collapse, respectively, the wagon 100. To deploy the wagon 100, cross-member 111 is rotated in a clockwise direction about pivot point 117 as cross-member 114 is rotated counterclockwise about pivot point 117, as viewed from the outside of the wagon 100. When this occurs, slider joints 276, 278 slide downward on tower members 192, 194, respectively. To collapse the wagon 100, cross-member 111 is rotated in a counterclockwise direction about pivot point 117 as cross-member 114 is rotated clockwise about pivot point 117, as viewed from the outside of the wagon 100. When this occurs, slider joints 276, 278 slide upward on tower members 192, 194, respectively.

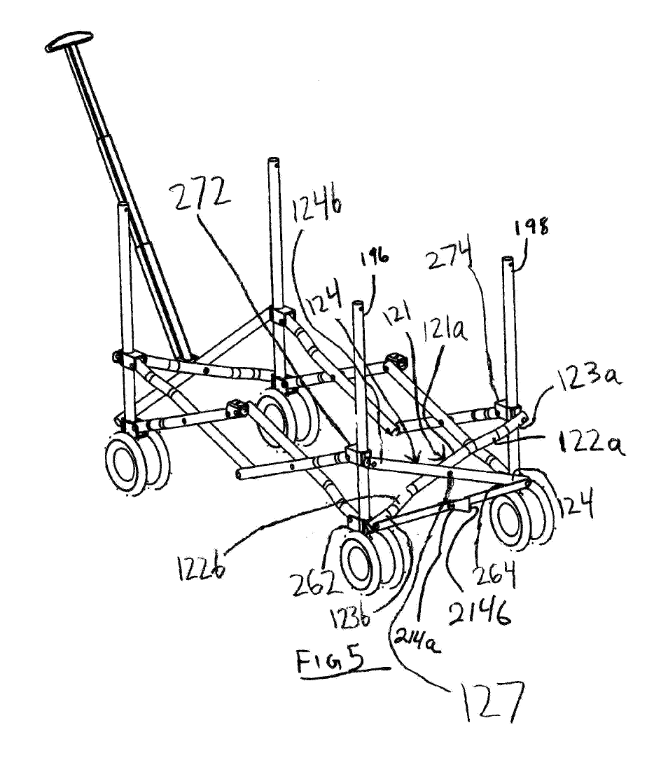

FIGS. 5 and 6 show the back cross-member pair 120, which connects first rear side cross-member pair 160 and second rear side cross-member pair 150. Back cross-member pair 120 comprises an inner cross-member 121 and an outer cross-member 124 connected at pivot point 127. The inner cross-member 121 has a first end 123a and a second end 123b that are outwardly offset from the main portion 121a by outward angled portions 122a and 122b, respectively. The pivot point 127 may be located at a intermediate location along the length of the cross-members 121, 124. Alternatively, the pivot point 127 may be located at a non-midpoint location along the length of the cross-members 121, 124. Outer cross-member 124 is straight along its length and has right and second ends 124a and 124b, respectively.

The first ends 123a, 124a of the cross-members 121 and 124 are opposite second ends 124b, 123b, respectively. The first end 123a of cross-member 121 is connected to slider joint 274, located slidably on tower member 198. The second end 123b of cross-member 121 is connected to fixed joint 262, located on a bottom portion of the tower member 196. The first end 124a of cross-member 124 is connected to fixed joint 264, located on a bottom portion of the tower member 198. The second end 124b of cross-member 124 is connected to slider joint 272, located slidably on tower member 196. The inner surfaces of cross-members 121, 124 face the outer surfaces of slider joints 272, 274, fixed joints 262, 264, and tower members 196, 198.

The back cross-member pair 120 forms an X-shaped section. The X-shaped section of the back cross-member pair 120 opens and closes to deploy and collapse the wagon 100. To deploy the wagon 100, cross-member 121 is rotated in a clockwise direction about pivot point 127 as cross-member 124 is rotated counterclockwise about pivot point 127, as viewed from the outside of the wagon 100. When this occurs, slider joints 272, 274 slide downward on tower members 196, 198, respectively. To collapse the wagon 100, cross-member 121 is rotated in a counterclockwise direction about pivot point 127 as cross-member 124 is rotated clockwise about pivot point 127, as viewed from the outside of the wagon 100. When this occurs, slider joints 272, 274 slide upward on tower members 196, 198, respectively.

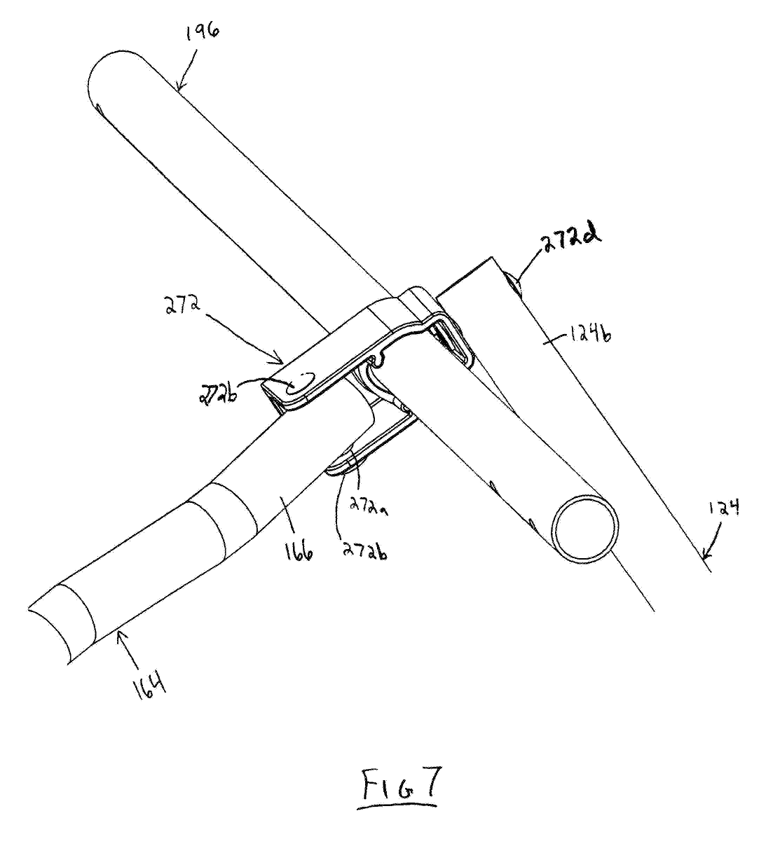

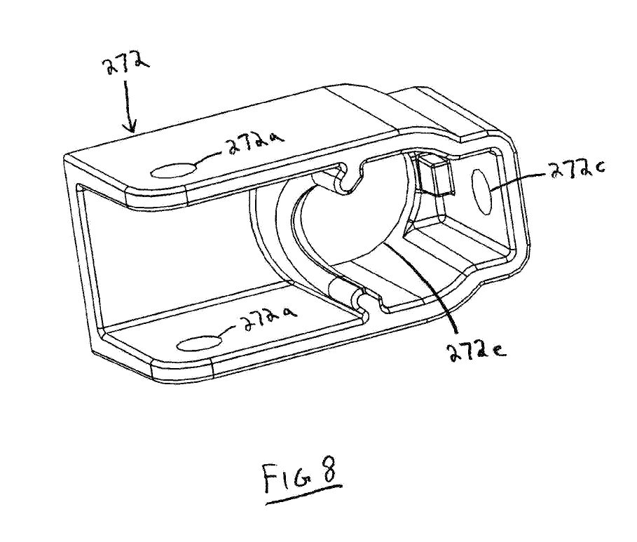

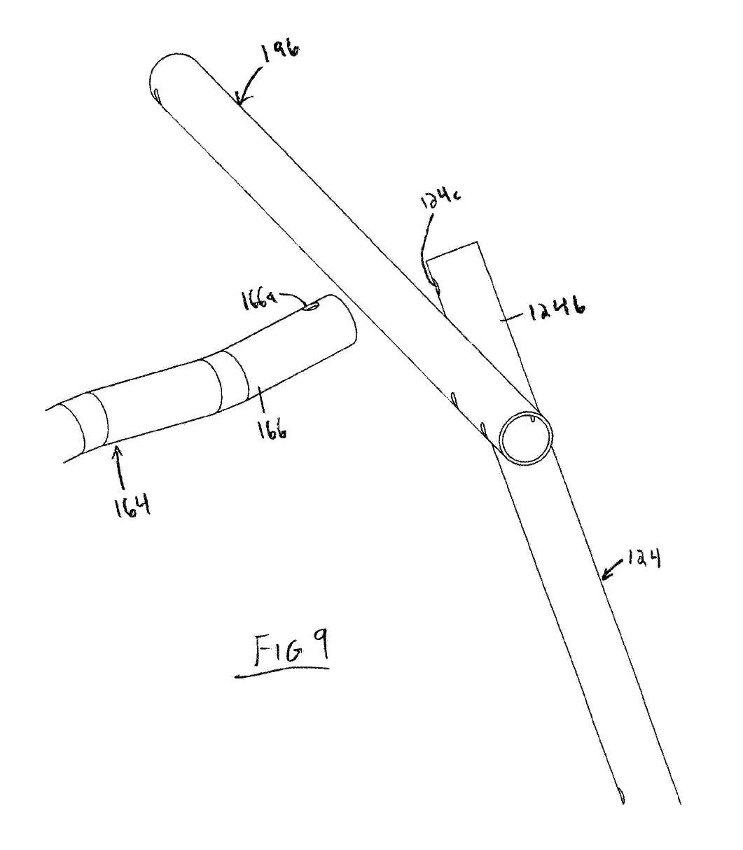

FIGS. 7-9 show a slider joint. All four slider joints 272, 274, 276, 278 are configured in the same manner. FIG. 7-9 show slider joint 272. Slider joint 272 interacts with two cross-members 124, 164, and tower member 196. The rear end 166 of cross-member 164 is inserted into an open end of slider joint 272. A first pin 272b is inserted through the first holes 272a of slider joint 272 then inserted through the holes 166a of cross-member rear end 166. This configuration assures that cross-member 164 is pivotably mounted to the inside of slider joint 272. A second pin 272d is inserted through a second hole 272c in slider joint 272 and then inserted through holes 124c on second end 124b. This configuration assures that cross-member 124 is pivotally mounted on the outside of slider joint 272. Upwardly extending member 196 is inserted through sliding hole 272e, so that slider joint 272 is slidably secured along the length of tower member 196.

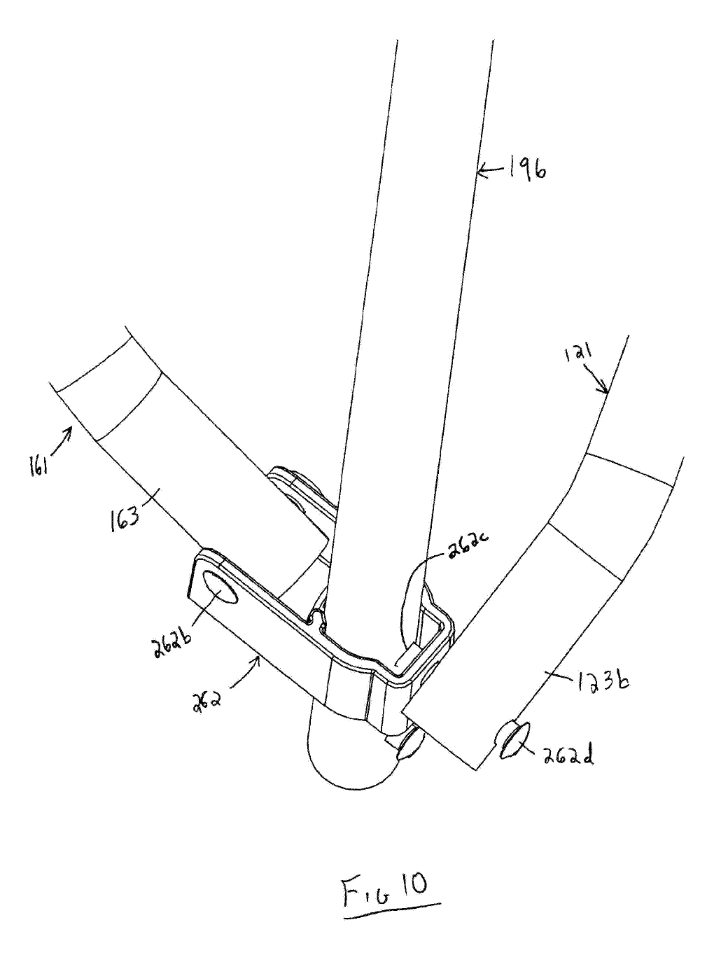

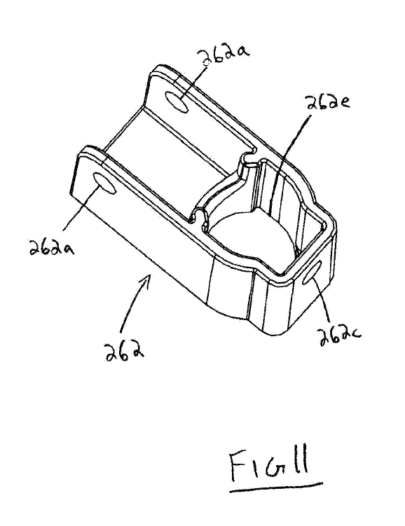

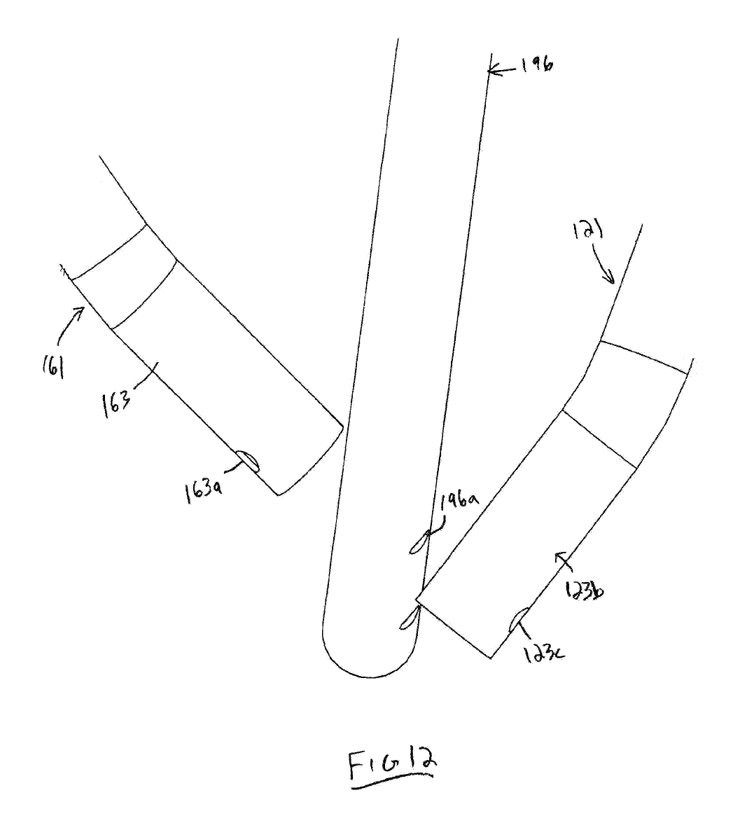

FIGS. 10-12 show a fixed joint. All four fixed joints 262, 264, 266, 268 are configured in the same manner. FIGS. 10-12 show fixed joint 262. Fixed joint 262 interacts with two cross-members 121, 161, and tower member 196. The rear end 163 of cross-member 161 is inserted into an open end of fixed joint 262. A first pin 262b is inserted through the first holes 262a of fixed joint 262 then inserted through the holes 163a of rear end 163. This configuration assures that cross-member 161 is pivotably mounted to the inside of fixed joint 262. A second pin 262d is inserted through a second hole 262c in fixed joint 262, inserted through holes 123c on second end 123b, and then inserted through holes 196a on tower member 196. This configuration assures that cross-member 121 is pivotally mounted on the outside of fixed joint 262, and that tower member is not longitudinally movable with respect to fixed joint 262.

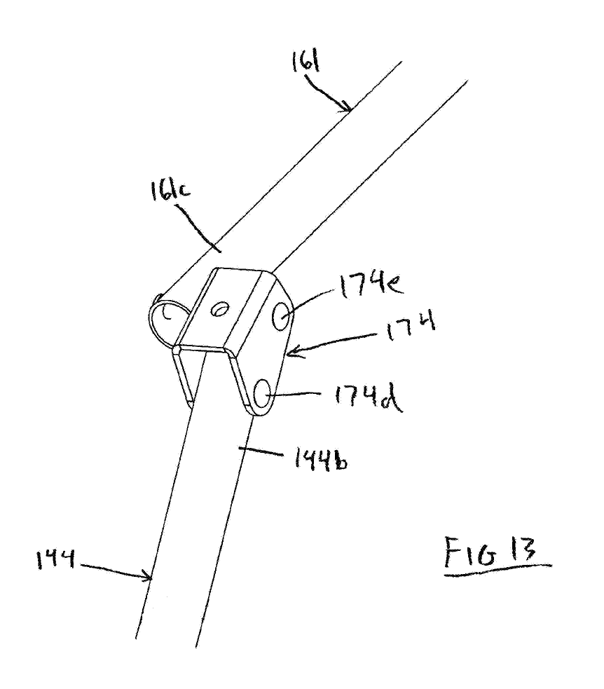

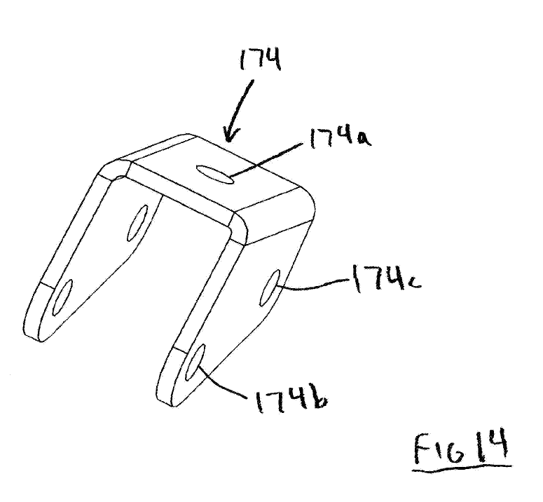

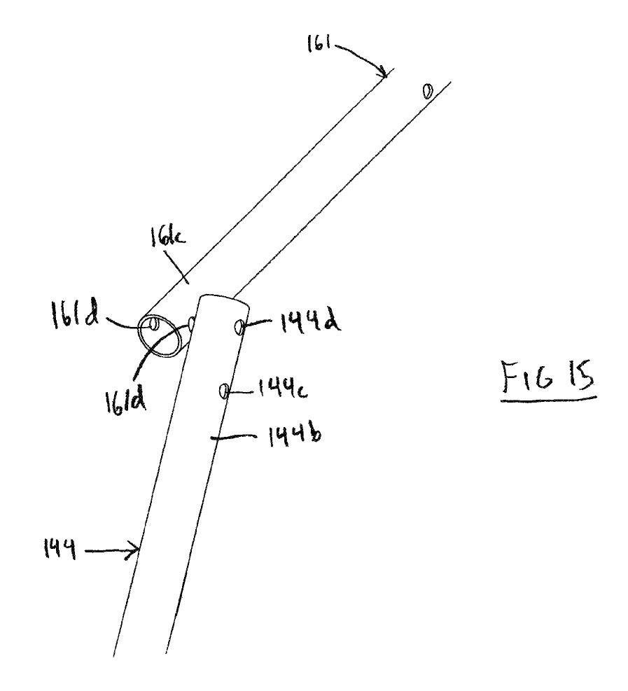

FIGS. 13-15 show an upper middle support joint. Both upper middle support joints 172, 174 are configured in the same manner, differing only by being mirror-image reflections of one another. FIG. 13-15 shows an upper middle support joint 174. Upper middle support joint 174 connects two cross-members 144 and 161. Rear end 144b of cross-member 144 is secured to upper middle support joint 174 via two pins 174d, 174e. Pin 174d passes through hole 174b and hole 144c, and pin 174e passes through holes 174c, 144d, and hole 161d of cross-member 161. Front end 161c of cross-member 161 is pivotally secured to the inside of upper middle support joint 174 via pin 174e in holes 161d. In this configuration, upper middle support joint 174 is rotationally fixed on cross-member 144, and cross-member 161 is pivotally mounted to upper middle support joint 174, making cross-members 161 and 144 pivotably attached at their front and rear ends 161c, 144b, respectively. FIG. 16 shows the wagon of FIG. 1 with a cargo area 300 included. In one embodiment, the cargo area 300 comprises fabric forming a basket structure 305. The open, top edge 310 of basket structure 305 is attached to the top end of the tower members 192, 194, 196, 198, for a total of four connections. As shown in FIG. 16 the basket may comprise upper tower connectors 340, 342, 344, 346 to connect the basket to the top of the tower members. The connectors may have a top portion 343, for securing the connector at the top of the tower. In another embodiment, the connectors may be secured through holes in an upper portion of the tower members. Additionally, the basket may be secured at a number of location along the length of the tower member by fasteners, such as, hook and loop fasteners, string, fabric loops, or other known fasteners.

A bottom edge 315 of basket structure 305 is preferably slidably mounted on the tower members 192, 194, 196, 198, and rests on and the slider joints 276, 278, 272, 274 and upper middle support joints 172, 174. The bottom edge 315 may have holes for receiving the tower members or the bottom of the basket may have loops extending at the edges of the bottom for receiving the tower members. It is preferred that the basket be attached at the bottom to the tower members to provide support to the items to be carried in the basket. The attachment of the bottom of the basket to the frame alleviates the need for additional support panels under the basket to support the payload to be carried in the basket.

When the wagon 100 is being collapsed and the slider joints 276, 278, 272, 274 and upper middle support joints 172, 174 slide upward, the framework 105 of the wagon 100 is condensed and occupies a much smaller area. In addition, the bottom edge 315 of the cargo area 300 is pushed upward and the basket structure 305 of the cargo area 300 is condensed into a small area. When the wagon 100 is being deployed and the slider joints 276, 278, 272, 274 and upper middle support joints 172, 174 slide down, the framework 105 of the wagon is expanded into a larger configuration. In addition, the bottom edge 315 slides downward to fully open the basket structure 305 of the seating area 300.

In one embodiment, the components of the framework 105 of the wagon 100, including the cross-members, the tower members, the slider joints, and the upper middle support joints are made of a sturdy but lightweight material, such as hollow metal. A handle 180 on the front of the wagon 100 is retractable as shown in FIG. 6A and attached to the framework 105. The handle has a pivotal attachment to the frame. The handle may be attached to the front or the back of the frame. In another embodiment, the handle may be a cord. In one embodiment, the handle is made of three sections of decreasing width 184, 185, and 186 as shown in FIG. 1. To collapse the handle, section 186 slides into section 185, and section 185 then slides into section 184. The handle 180 further comprises a T-shaped gripping portion 187.

In one embodiment, the locking mechanism 210 comprises a latch and two rods 212, 213. The rods 212, 213 may be equal length. The rods are connected by a pin (not shown) at a pivot 214a. The ends are attached to fixed joints 262, 264 through the second pin 272b and pivotable about the pin. The two rods pivot in the middle to fold upward when the wagon is folded. The rods 212, 213 fold downward when the wagon is expanded until they are both horizontal. A third locking piece 214 has an inwardly extending portion 214b that makes contact with the underside of rod 213 to hold the rods a substantially horizontal and locked position when the wagon is in the expanded position. The locking piece 214 may be manually pushed upward to allow the rods to rotate when the wagon is in the folded position.

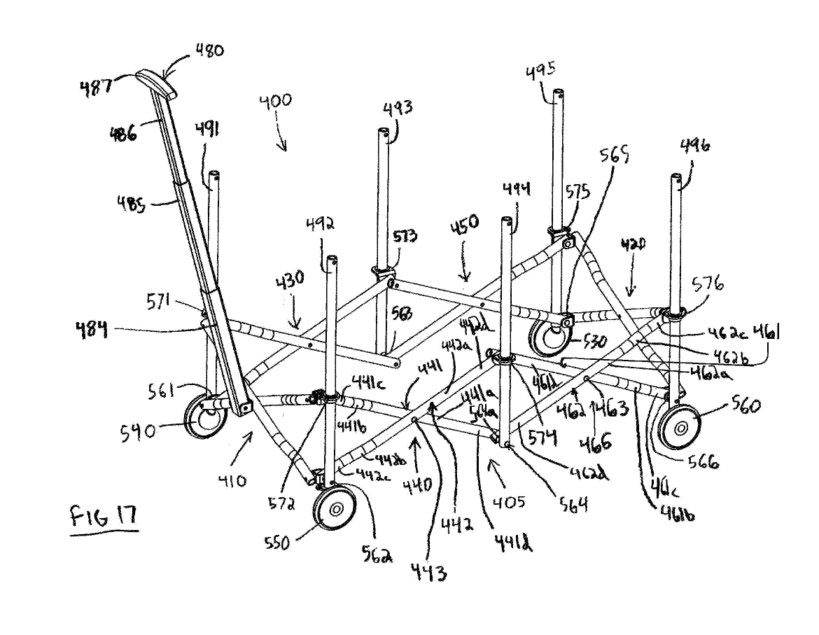

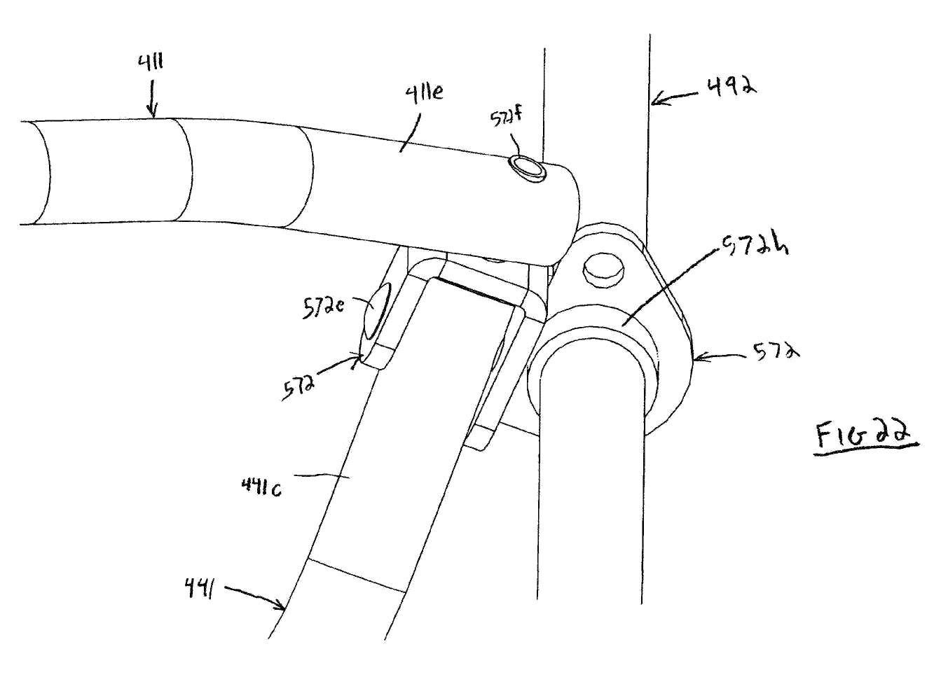

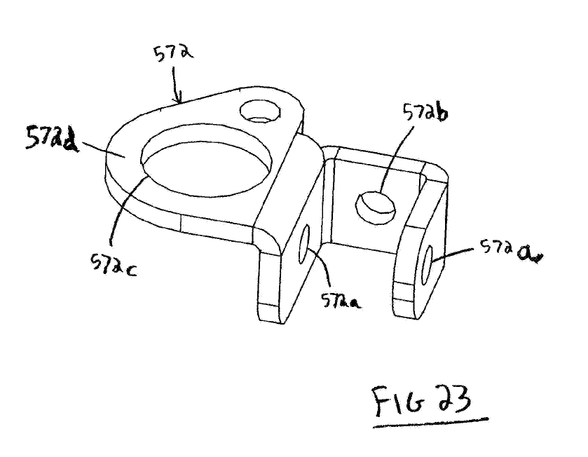

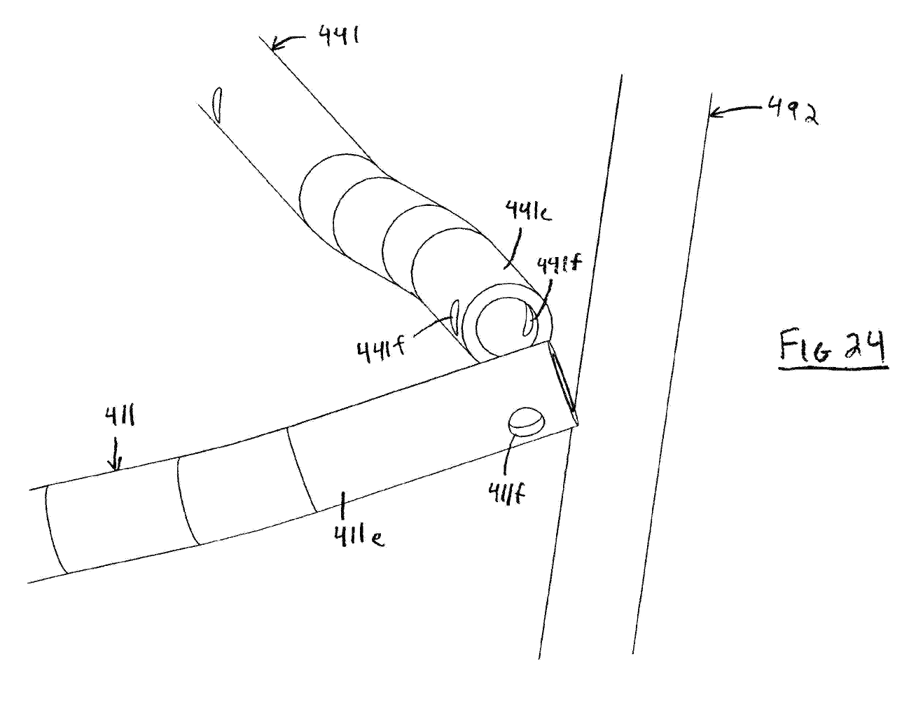

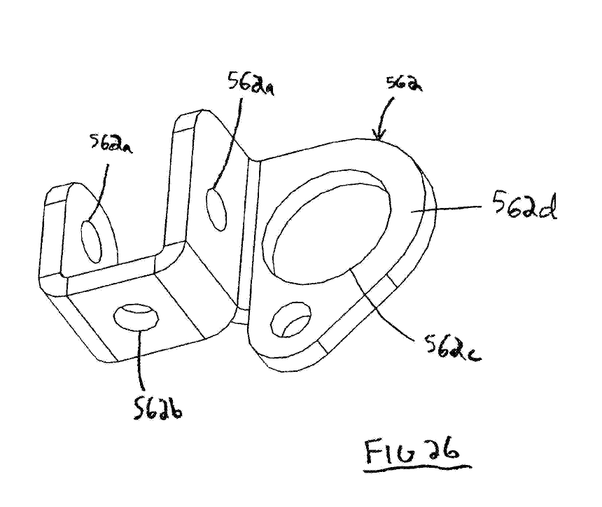

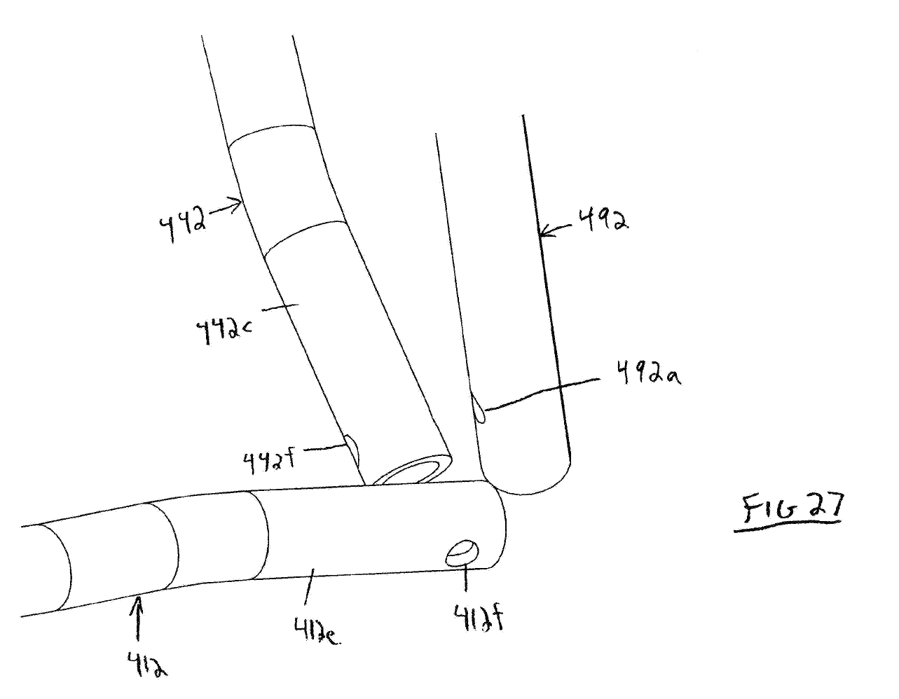

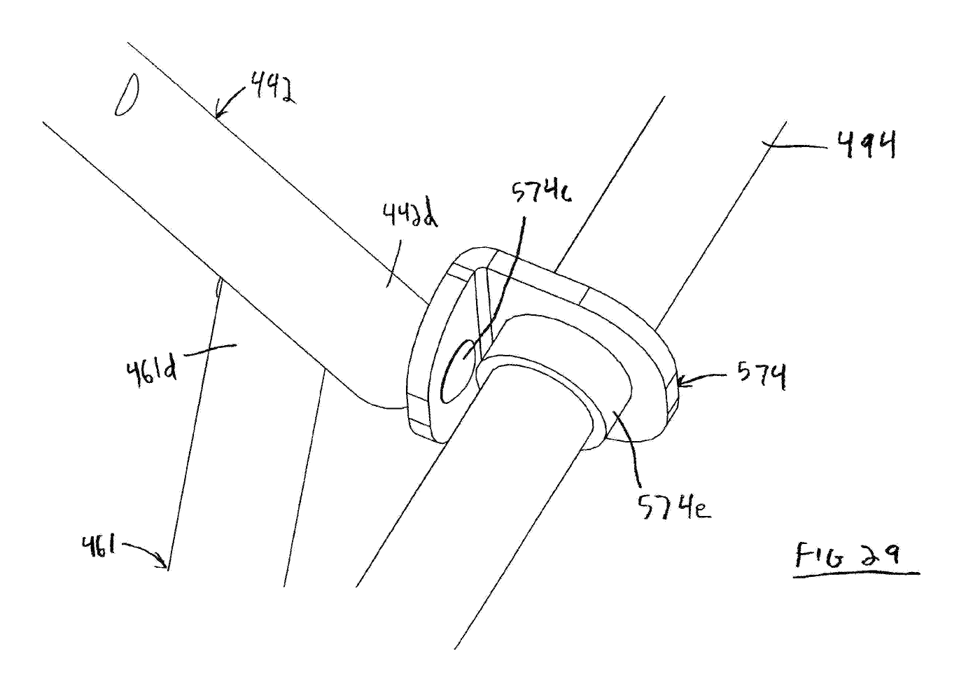

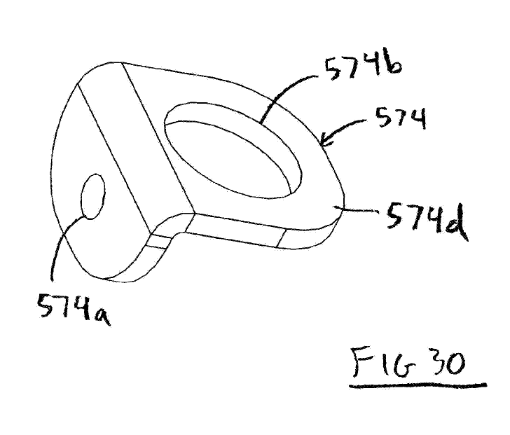

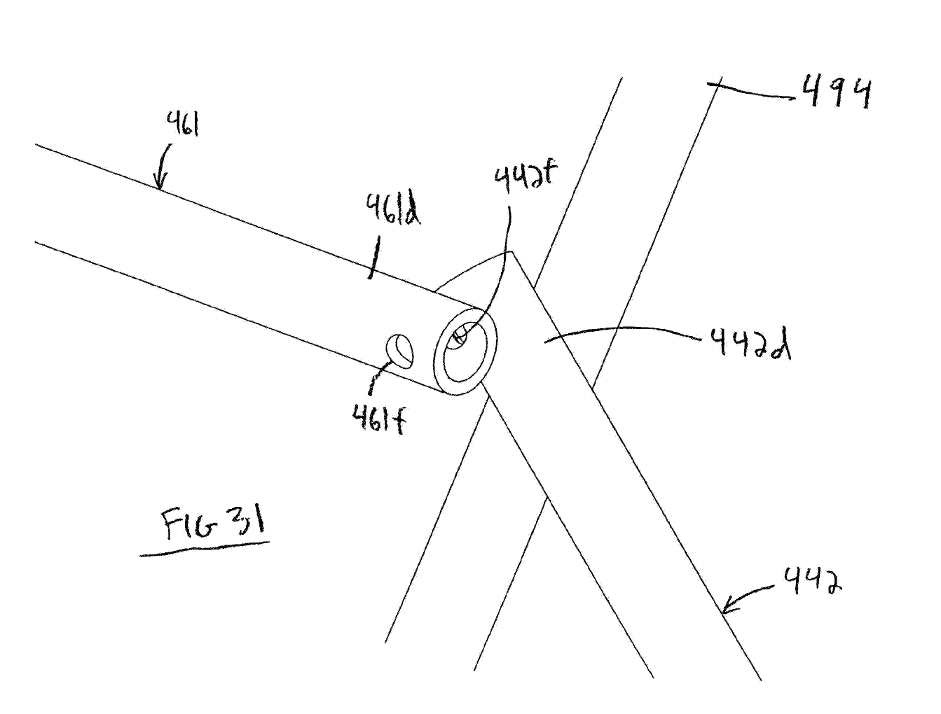

FIGS. 17-20 show perspective views of a second embodiment of the wagon 400 constructed similarly to the wagon 100 except as described below and shown in FIGS. 17-32. FIG. 17 shows the wagon 400 without the cargo area 600. The wagon 400 has a framework 405. The framework 405 comprises a front cross-member pair 410, a back cross-member pair 420, a first forward side cross-member pair 440, a first rear side cross-member pair 460, a second forward side cross-member pair 430, a second rear side cross-member pair 450, six tower members 491, 492, 493, 494, 495, 496 four corner slider joints 571, 572, 575, 576, two side slider joints 573, 574, four corner fixed joints 561, 562, 565, 566, and two side fixed joints 563, 564. The wagon 400 has two front wheels 540, 550 operatively connected to front bottom corners of the framework 405, and two rear wheels 530, 560 operatively connected to rear bottom corners of the framework 405. At least the front wheels being pivotable for steering the wagon.

Each cross-member pair is joined at each end of the cross-member pair to an adjacent cross-member pair in the series of cross-member pairs, which forms the perimeter of the framework 405. The first forward side cross-member pair 440 and the first rear side cross-member pair 460 comprise a first side 406 of the framework 405. The second forward side cross-member pair 430 and the second rear side cross-member pair 450 comprise an opposite second side 407 of the framework. The first 406 and second 407 sides of the frame work 405 are connected and spaced apart by the front cross-member pair 410 and the back cross-member pair 420.

The first side 406 of the framework 405 will be described. It is understood that the second side 407 of the framework 405 is mirror image identical to the first side 106 across a vertical mid-plane defined by pivot joints 413, 423 of the front 410 and rear 420 cross-member pairs. The first forward side cross-member pair 440 comprises an inner cross-member 441 and an outer cross-member 442 connected at pivot point 443. The inner cross-member 441 has a front end 441c that is outwardly offset from the main portion 441a by an outward angled portion 441b. The outer cross-member 442 has a front end 442c that is inwardly offset from the main portion 442a by an inward angled portion 442b. The first rear side cross-member pair 460 has an inner cross-member 461 and an outer cross-member 462 connected at a pivot point 463. The inner cross-member 461 has a rear end 461c that is outwardly offset from the main portion 461a by an outward angled portion 461b. The outer cross-member 462 has a rear end 462c that is inwardly offset from the main portion 462a by an inward angled portion 462b. The pivot points 443, 463 may be located at a intermediate location along the length of each cross-member 441, 442 and 461, 462, respectively. Alternatively the pivot points 443, 463 may be located at a non-midpoint location along the length of each cross-member.

The front ends 441c, 442c of the cross-members 441, 442 are opposite rear ends 442d, 441d, respectively. The front ends 461d, 462d of the cross-members 461, 462 are opposite rear ends 462c, 461c, respectively. A side fixed joint 564 connects the rear end 441d of cross-member 441 to the front end 462d of cross-member 462. A bushing 564a is located between tower member 494 and front end 462d and surrounds a pin 564b. The pin runs through tower member 494, front end 462d and rear end 441d. The rear end 442d of cross-member 442 connects at the side slider joint 574 to the front end 461d of cross-member 461. The inside surface of cross-member 462 faces the outside surface of cross-member 441 and the outside surface of cross-member 462 faces the inside surface of tower member 494 at the side fixed joint 564. The inside surface of cross-member 442 faces the outside surface of cross-member 461 and the outside surface of cross-member 442 faces the inside surface of tower member 494 at the side slider joint 574. The front end 441c of cross-member 441 connects to slider joint corner slider joint 572, located slidably on tower member 492. The front end 442c of cross-member 442 connects to corner fixed joint 562, located on a bottom portion of the tower member 492. The rear end 462c of cross-member 462 connects to corner slider joint 576, located slidably on tower member 496. The rear end 461c of cross-member 461 connects to corner fixed joint 566, located on a bottom portion of the tower member 496. The rear ends 462c, 461c of the first rear side cross-member pair 460 are offset in opposite directions. The front ends 441c, 442c of the first front side cross-member pair 440 are offset in opposite directions.

The first forward side cross-member pair 440 and the first rear side cross-member pair 460 form two X-shaped sections. The X-shaped section of the first forward side cross-member pair 440 opens and closes to deploy and collapse the wagon 400. To deploy the wagon 400, cross-member 442 is rotated in a clockwise direction about pivot point 443 as cross-member 441 is rotated counterclockwise about pivot point 443, as viewed from the outside of the wagon 400. When this occurs, corner slider joint 572 slides downward on tower member 491 and toward corner fixed joint 562. Similarly, side slider joint 574 moves downward and toward side fixed joint 564. To collapse the wagon 400, cross-member 462 is rotated in a counterclockwise direction about pivot point 463 as cross-member 461 is rotated clockwise about pivot point 463, as viewed from the outside of the wagon 400. When this occurs, corner slider joint 572 slides upward on tower member 492 and away from corner fixed joint 562. Similarly, side slider joint 574 moves upward and away from side fixed joint 564.

The X-shaped section of the first rear side cross-member pair 460 opens and closes to deploy and collapse the wagon 400. To deploy the wagon 400, cross-member 462 is rotated in a clockwise direction about pivot point 463 as cross-member 461 is rotated counterclockwise about pivot point 463, as viewed from the outside of the wagon 100. When this occurs, corner slider joint 576 slides downward on tower member 496 and toward corner fixed joint 566. Similarly, side slider joint 574 moves downward and toward side fixed joint 564. To collapse the wagon 400, cross-member 462 is rotated in a counterclockwise direction about pivot point 463 as cross-member 461 is rotated clockwise about pivot point 463, as viewed from the outside of the wagon 400. When this occurs, corner slider joint 576 slides upward on tower member 496 and away from corner fixed joint 566. Similarly, side slider joint 574 moves upward and away from side fixed joint 564.

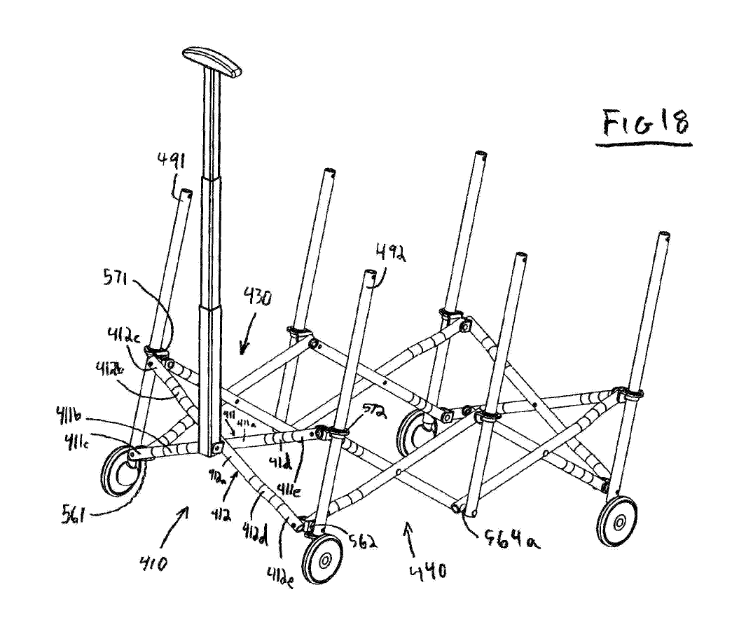

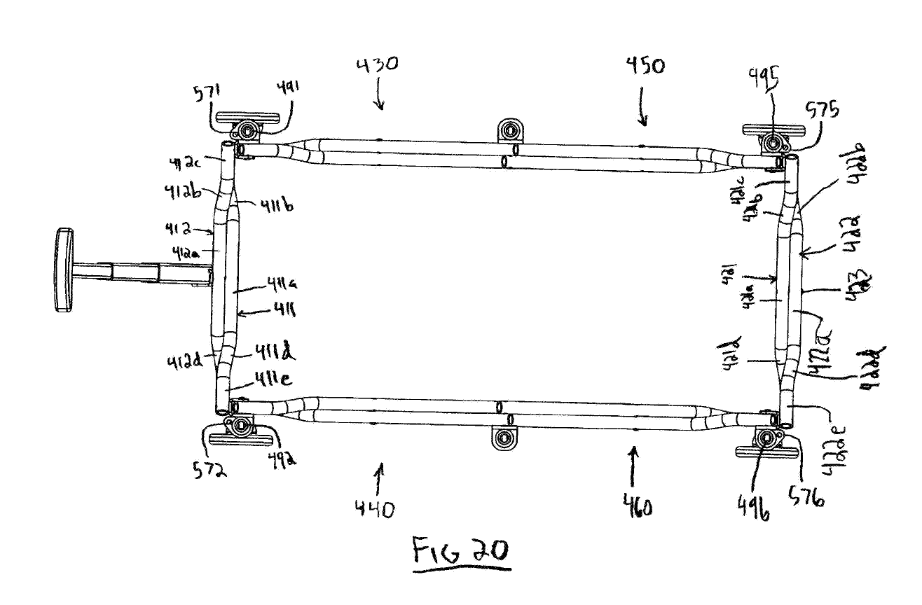

FIGS. 18 and 20 show a perspective and top views of the front cross-member pair 410, which connects first forward side cross-member pair 440 and second forward side cross-member pair 430. Front cross-member pair 410 comprises an inner cross-member 411 and an outer cross-member 412 connected at pivot point 413. The inner cross-member 411 has a first end 411c and a second end 411e that are outwardly offset from the main portion 411a by outward angled portions 411b and 411d, respectively. The outer cross-member 412 has a first end 412c and a second end 412e that are inwardly offset from the main portion 412a by outward angled portions 412b and 412d, respectively. The pivot point 413 may be located at a intermediate location along the length of the cross-members 411, 412. Alternatively, the pivot point 413 may be located at a non-midpoint location along the length of the cross-members 411, 412.

The first ends 411c, 412c of the cross-members 411 and 412 are opposite second ends 412e, 411e, respectively. The first end 411c of cross-member 411 is connected to corner fixed joint 561, located on a bottom portion of the tower member 491. The second end 411e of cross-member 411 is connected to corner slider joint 572, located slidably on tower member 492. The first end 412c of cross-member 412 is connected to corner slider joint 571, located slidably on tower member 491. The second end 412e of cross-member 412 is connected to corner fixed joint 562, located on a bottom portion of the tower member 492.

The front cross-member pair 410 forms an X-shaped section. The X-shaped section of the front cross-member pair 410 opens and closes to deploy and collapse the wagon 400. To deploy the wagon 400, cross-member 411 is rotated in a clockwise direction about pivot point 413 as cross-member 412 is rotated counterclockwise about pivot point 412, as viewed from the outside of the wagon 400. When this occurs, slider joints 571, 572 slide downward on tower members 491, 492, respectively. To collapse the wagon 400, cross-member 411 is rotated in a counterclockwise direction about pivot point 413 as cross-member 412 is rotated clockwise about pivot point 413, as viewed from the outside of the wagon 400. When this occurs, slider joints 571, 572 slide upward on tower members 491, 492, respectively.

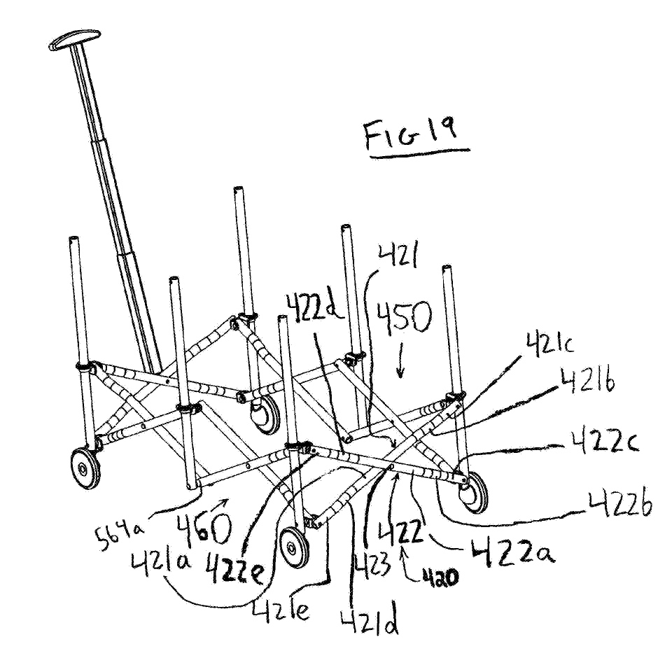

FIGS. 19 and 20 show perspective and top views of back cross-member pair 420, which connects first rear side cross-member pair 460 and second rear side cross-member pair 450. Back cross-member pair 420 comprises an inner cross-member 421 and an outer cross-member 422 connected at pivot point 423. The inner cross-member 421 has a first end 421c and a second end 421e that are outwardly offset from the main portion 421a by outward angled portions 421b and 421d, respectively. The outer cross-member 422 has a first end 422c and a second end 422e that are outwardly offset from the main portion 422a by outward angled portions 422b and 422d, respectively. The pivot point 423 may be located at an intermediate location along the length of the cross-members 421, 422. Alternatively, the pivot point 423 may be located at a non-midpoint location along the length of the cross-members 421, 422.

The first ends 421c, 422c of the cross-members 421 and 422 are opposite second ends 422e, 422e, respectively. The first end 421c of cross-member 421 is connected to corner slider joint 575, located slidably on tower member 495. What are you French and The second end 422e of cross-member 422 is connected to corner slider joint 576, located slidably on tower member 496.

The back cross-member pair 420 forms an X-shaped section. The X-shaped section of the back cross-member pair 420 opens and closes to collapse and deploy the wagon 400. To deploy the wagon 400, cross-member 421 is rotated in a clockwise direction about pivot point 423 as cross-member 422 is rotated counterclockwise about pivot point 423, as viewed from the outside of the wagon 400. When this occurs, slider joints 575, 576 slide downward on tower members 495, 496, respectively. To collapse the wagon 400, cross-member 421 is rotated in a counterclockwise direction about pivot point 423 as cross-member 422 is rotated clockwise about pivot point 423, as viewed from the outside of the wagon 400. When this occurs, slider joints 575, 576 slide upward on tower members 495, 496, respectively.

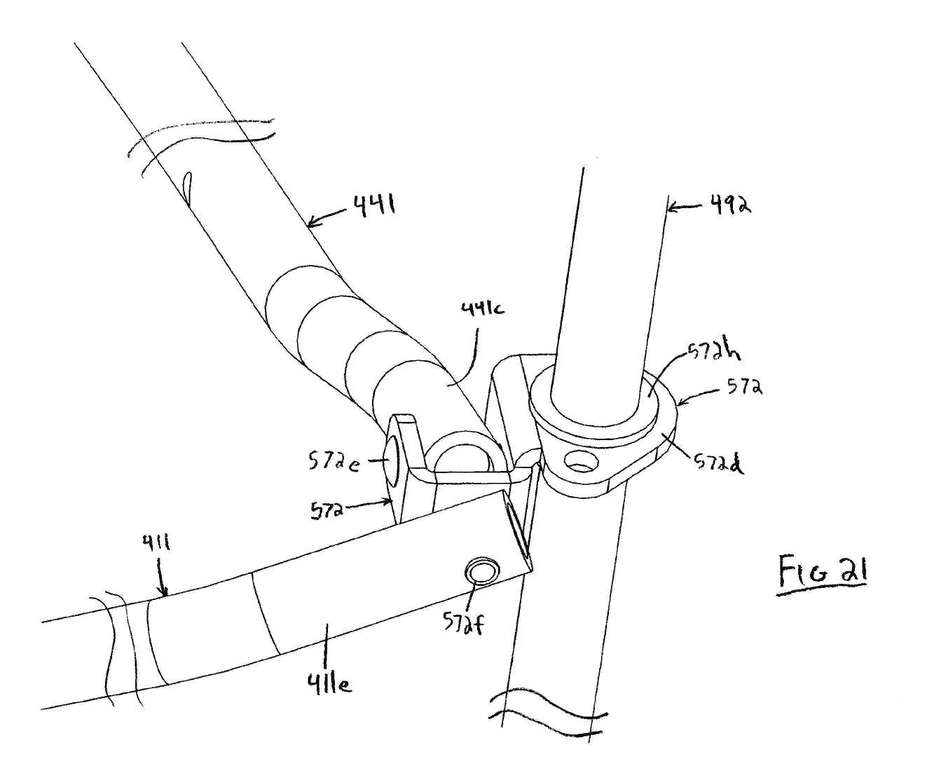

FIGS. 21-24 show perspective views of a corner slider joint. All four corner slider joints 571, 572, 575, 576 are configured in the same manner. FIGS. 21-24 show slider joint 572. Slider joint 572 interacts with two cross-members 411, 441, and tower member 492. The front end 441c of cross-member 441 is inserted into an open area of slider joint 572. A first pin 572e is inserted through the first holes 572a of slider joint 572 then inserted through the holes 441f of the cross-member rear end 441c. This configuration assures that cross-member 441 is pivotably mounted to slider joint 572. A second pin 572f is inserted through a second hole 572b in slider joint 572 and then inserted through holes 411f on second end 411e of cross-member 411. This configuration assures that cross-member 411 is pivotally mounted on the outside of slider joint 572. Upwardly extending member 492 is inserted through sliding hole 572c, so that slider joint 572 is slidably secured along the length of tower member 492. A bushing 572h surrounds tower member 492 at the location of slider joint 572. A top surface 572d of corner slider joint 572 is configured to support a bottom side of cargo area 600.

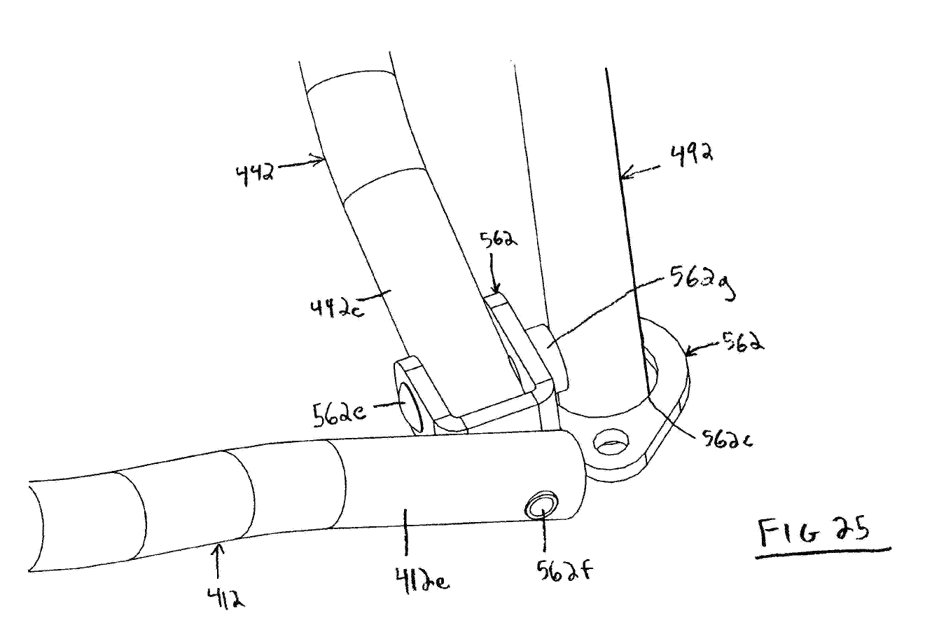

FIGS. 25-27 show perspective views a corner fixed joint. All four fixed joints 561, 562, 565, 566 are configured in the same manner. FIGS. 25-27 show fixed joint 562. Fixed joint 562 interacts with two cross-members 412, 442, and tower member 492. The front end 442c of cross-member 442 is inserted into an open end of fixed joint 562. A first pin 562e is inserted through the first holes 562a of fixed joint 562, inserted through the holes 442f of rear end 442c of cross-member 442, then inserted in mounting holes 492a of tower member 492. This configuration assures that cross-member 442 is pivotably mounted fixed joint 562. A second pin 562f is inserted through a second hole 562b in fixed joint 562, then inserted through holes 412f on second end 412f of cross-member 412. A bushing 562g surrounds first pin 562e between tower member 492 and corner fixed joint 562. This configuration assures that cross-members 412, 442 is pivotally mounted on fixed joint 562, and that tower member 492 is not longitudinally movable with respect to fixed joint 562.

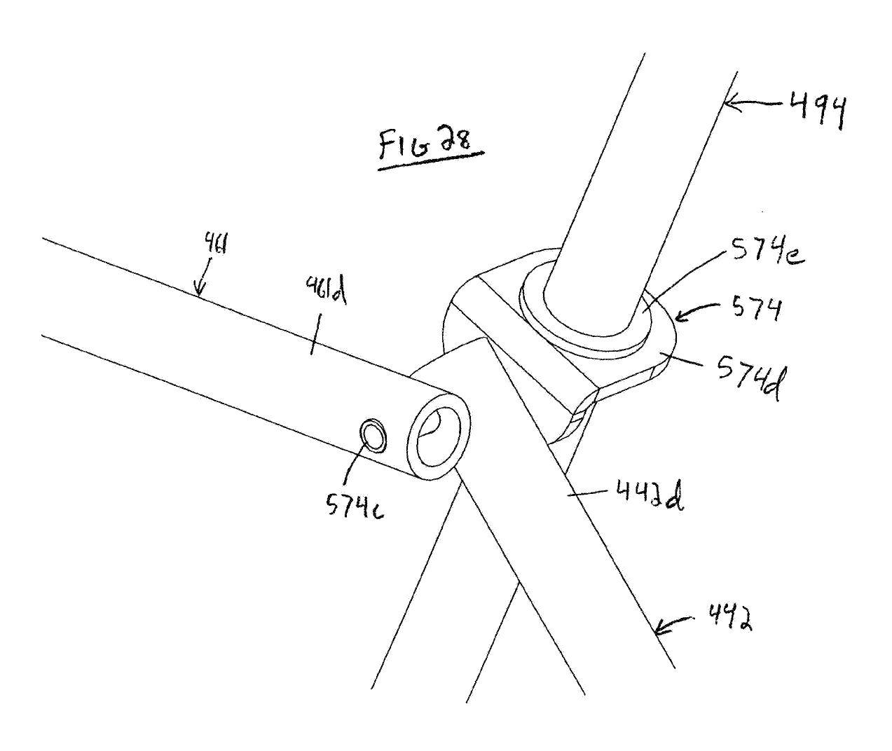

FIGS. 28-31 show perspective views of a side slider joint. The two side slider joints 573, 574 are configured in the same manner. FIGS. 28-31 show slider joint 574. Side slider joint 574 interacts with two cross-members 442, 461, and tower member 494. The front end 461d of cross-member 461 is attached to rear end 442d of cross-member 442 and side slider joint 574 via a pin 574c. Pin 574c passes through hole 461f in cross-member 461, hole 442f in cross-member 442, and then passes through hole 574a in slider joint 574. Upwardly extending member 494 is inserted through sliding hole 574b. This configuration assures that cross-members 442, 461 are pivotably mounted on slider joint 574. In addition, slider joint 574 is longitudinally slidable on tower member 494. A bushing 574e surrounds tower member 494 at the location of slider joint 574. A top surface 574d of corner slider joint 574 is configured to press against a bottom side of cargo area 600.

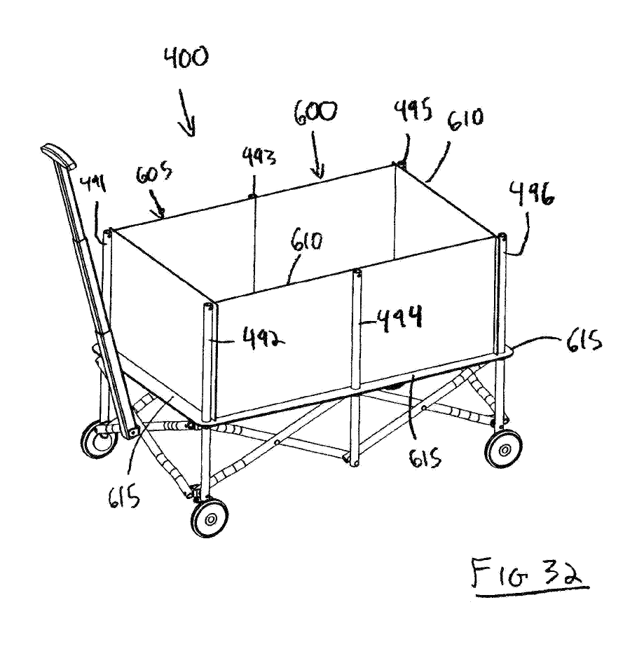

FIG. 32 shows the wagon of FIG. 17 with a cargo area 600 included. In one embodiment, the cargo area 600 comprises fabric forming a basket structure 605. The open, top edge 610 of basket structure 605 is attached to the top end of the supports 491, 492, 493, 494, 495, 496 for a total of six connections. A bottom edge 615 of basket structure 605 is preferably slidably mounted on the supports 491, 492, 493, 494, 495, 496 and rests on and the slider joints 571, 572, 575, 576 and side slider joints 573, 574.

When the wagon 400 is being collapsed and the corner slider joints 571, 572, 575, 576 and side slider joints 573, 574 slide upward, the framework 405 of the wagon 400 is condensed and occupies a much smaller area, similar to the collapsed configuration shown in FIG. 6A of the first embodiment. In addition, the bottom edge 615 of the cargo area 600 is pushed upward and the basket structure 605 of the cargo area 600 is condensed into a small area. When the wagon 400 is being deployed and the corner slider joints 571, 572, 575, 576 and side slider joints 573, 574 slide down, the framework 405 of the wagon is expanded outward from the center into a larger configuration. In addition, the bottom edge 615 slides downward to fully open the basket structure 605 of the cargo area 600. In one embodiment, the cargo area 600 is similar to the cargo area 300 with the addition of connection between the side tower members 493, 494. The tower members may comprise holes 497 for receiving a connector to attach the basket 610 to the tower members. It is preferred that the basket be attached at the bottom to the tower members to provide support to the items to be carried in the basket. Other connecting configurations between the basket and the frame or tower members are within the scope of the wagon 100, 400, 700. The attachment of the bottom of the basket to the frame alleviates the need for additional support panels under the basket to support the payload to be carried in the basket. The attachment of the upper portion or the top of the basket to the tower members also support a payload and in combination with the bottom attachment alleviates the need for additional support panels under the basket to support the payload to be carried in the basket.

In one embodiment, the components of the framework 405 of the wagon 400, including the cross-members, the tower members, the slider joints, and the upper middle support joints are made in a sturdy but lightweight configuration, such as hollow metal. A handle 480 on the front of the wagon 400 is retractable and attached to the framework 405. In one embodiment, the handle is made of three sections of decreasing width 484, 485, and 486. To collapse the handle, section 486 slides into section 485, and section 485 then slides into section 484. Handle 480 further comprises a T-shaped gripping portion 487.

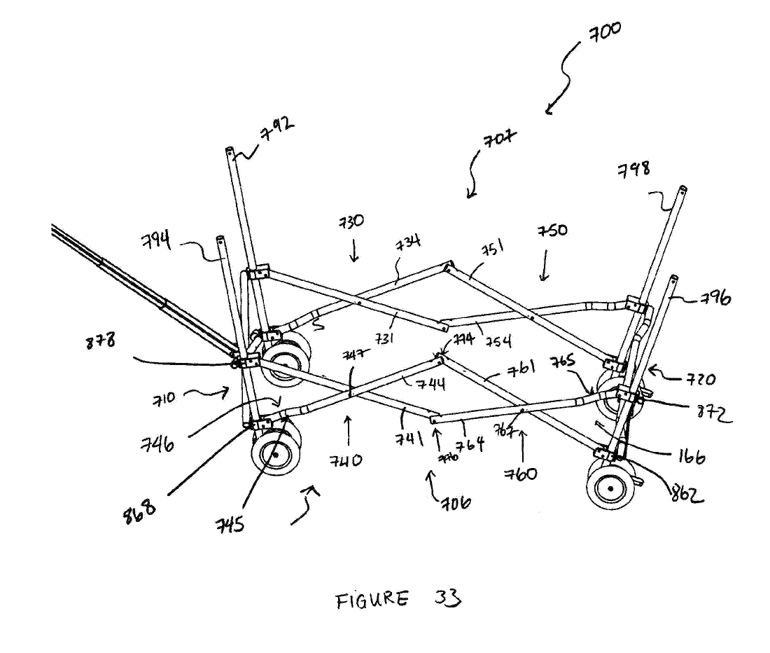

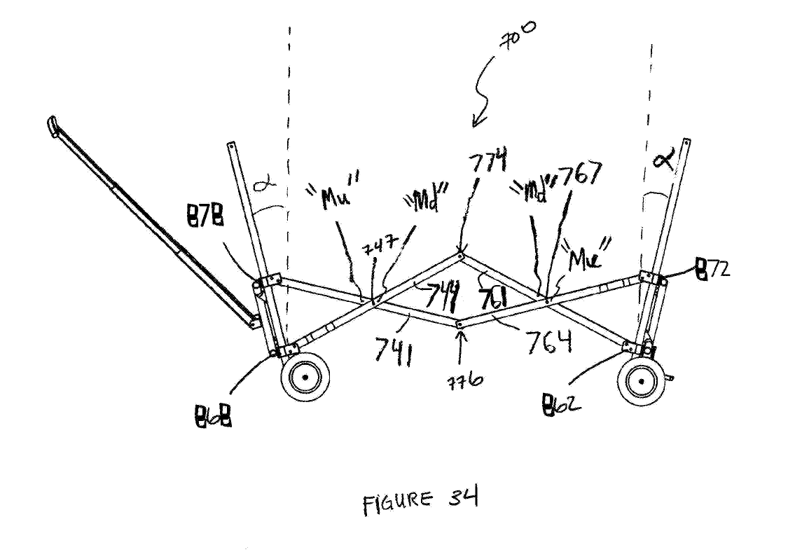

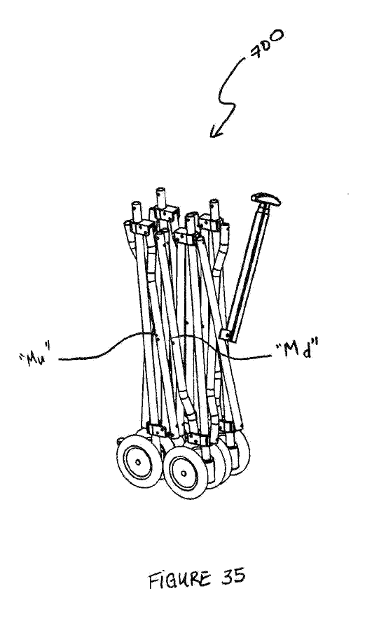

FIGS. 33-35 illustrate another embodiment of the wagon 700 constructed similarly to the wagon 100 except as described below. FIG. 33-34 illustrates the wagon 700 in an expanded or deployed position, and FIG. 35 illustrates the wagon 700 it its collapsed position. In use, the frame is extended in two horizontal directions and a vertical direction. The framework 705 of the wagon 700 comprises a first forward side cross-member pair 740, a first rear side cross-member pair 760, a second forward side cross-member pair 730, a second rear side cross-member pair 760, and four tower members 792, 794, 796, 798.

Each cross-member pair 730, 740, 750, 760 is joined at each end of the cross-member pair to an adjacent cross-member pair in the series of cross-member pairs, which forms the perimeter of the framework 705. The first forward side cross-member pair 740 and the first rear side cross-member pair 760 comprise a first side 706 of the framework 705. The second forward side cross-member pair 730 and the second rear side cross-member pair 750 comprise an opposite second side 707 of the framework. The first 706 and second 707 sides of the frame work 705 are connected and spaced apart by the front cross-member pair 710 and the back cross-member pair 720. Each cross member pair comprises a two cross-member connected at an intermediate pivot location, and each cross-member of a cross-member pair is movable above the pivot location relative to the other cross-member in a scissoring motion. The scissoring cross-members extend in a vertical direction when the wagon 700 is in a collapsed position (FIG. 35).

The first side 706 of the framework 705 will be described. It is understood that the second side 707 of the framework 705 is mirror image identical to the first side 706 of the framework. The first forward side cross-member pair 740 comprises an inner cross-member 741 and an outer cross-member 744 connected at pivot point 747. The outer cross-member 744 has a front end 746 that is inwardly offset from the rest of the cross-member 744 by an inward angled portion 745. The first rear side cross-member pair 760 has an inner cross-member 761 and an outer cross-member 764 connected at a pivot point 767. The outer cross-member 764 has a rear end 766 that is inwardly offset from the rest of the cross-member by an inward angled portion 765. Cross-members 744, 761 are connected at a upper middle joint 774, and cross-members 741 and 764 are connected at a lower middle joint 776.

Cross-members 741, 764 extend upwards from the lower middle joint 776 upwards toward towers 794, 796 respectively, and are slidably connected to towers 794, 796 by way of slider joints 878, 872, above fixed joints 868, 862 on towers 794,796. Cross-members 744 and 761 extend downwards from the upper middle joint 774 towards towers 794, 796 respectively, and are connected to towers 794, 796 by way of the fixed joints 868, 862.

The pivot points 747, 767 are located at a non-midpoint location along the length of each cross-member 744, 761, 741, 764. The pivot points 747, 767 on the upward extending cross members 741, 764 are located at a location along the length of each cross-member such that the portion of cross-members 741, 764 extending from the lower middle joint 776 to the pivot point 747,767 is shorter than the portion of cross-members 741, 764 extending from the pivot point 747, 767 to the slider joints 878, 872. As illustrated in FIG. 34, the midpoint “Mᵤ” of each upward extending cross member 741, 764 is at a higher position than the pivot point 747, 767. Pivot points 747, 767 are located at a different position along the length of cross members 744, 761 than on cross members 741, 764. The pivot points 747, 767 on the downward extending cross members 744, 761 are located at a location along the length of each cross member such that the portion of cross-members 744, 761 extending from the upper middle joint 774 to the pivot point 747,767 is longer than the portion of cross-members 744, 761 extending from the pivot point 747, 767 to the slider joints 868, 862. As illustrated in FIG. 34, the midpoint “M_{d}” (shown for cross member 744), of each downward extending cross member 744, 761 is at higher position than pivot points 747, 767. Therefore, the midpoint “M_{d}” along cross-member 744 is closer to the end of the cross member at the upper middle pivot 744 than the end of the cross member at fixed joint 868. The midpoint “M_{d}” along cross-member 761 is closer to the end of the cross member at the upper middle pivot 744 than the end of the cross member at fixed joint 862.

As a result of having upward extending cross members 741, 764 with longer portions extending from the pivot point 774, 776 to the sliders 878, 872, and the downward extending cross members 744, 761 with shorter portions extending from pivot points 774, 776 to sliders 868, 862, the towers 794, 796, extend outwards at an angle “α” from a straight vertical position shown by the dashed line in FIG. 34 when the wagon is in a deployed position. One advantage of such an arrangement is that is can add stability to the wagon assembly when a child sits in the cargo area disposed within the framework 705.

FIG. 35 illustrates the wagon 700 in its collapsed position. As discussed in detail above, the first forward side cross-member pair 740 and the first rear side cross-member pair 760 form two X-shaped sections. The X-shaped section of the first forward side cross member pair 740 and the X-shaped section of the first rear side cross member pair 760 opens and closes to deploy or collapses the wagon. To deploy the wagon, cross-members 744, 764 are rotated in a clockwise direction about pivot points 747, 767 respectively, while cross members 741, 761 are rotated in a counter-clockwise position about pivot points 747, 767 respectively. During deployment, slider joints 878 and 872 slide down tower members 794, 796 towards fixed joints 868, 862 respectively, as upper middle joint 774 and lower middle joint 776 move toward each other. To collapse the wagon, cross-members 744, 764 are rotated in a counterclockwise direction about pivot points 747, 767 respectively, while cross members 741, 761 are rotated in a clockwise position about pivot points 747, 767 respectively. During collapsing of the wagon, slider joints 878, 872 slide up tower members 794, 796 away from fixed joints 868, 862 respectively, as upper middle joint 774 and lower middle joint 776 move away from each other. When the wagon has pivot points 747, 767 that are offset from the mid-points of the cross-members, then the wagon will collapse in three directions, wherein the third direction of collapse is the top of the towers 192, 194, 196, 198 arching inward as the wagon collapses.

The frame may comprise additional cross-member pairs in the front, back, or sides to change the overall size of the wagon. The ratio between the width and length may be varied in whole number increments, such as 1:2, 1:3, 1:4, 2:3, 2:5, etc. In one embodiment, the distance been the pivot points on each cross-member pair and an adjacent joints on each cross-member pair should be substantially the same.

From the foregoing, it will be observed that numerous variations and modifications may be effected without departing from the spirit and scope of the invention. It is to be understood that no limitation with respect to the specific apparatus illustrated herein is intended or should be inferred.

I claim:

1. A folding wagon, comprising:
a collapsible frame having a front end, a back end and two opposite sides, four corners, and at least one tower member at each of the corners; the front end, the back end, and the two opposite sides have at least one cross-member pair;
the cross-member pairs have at least two cross-members connected at an intermediate pivot location; the cross-members are pivotable about the intermediate pivot location to move the frame between an expanded position and a collapsed position;
ends of the cross-members pairs at each corner are connected transversely to an adjacent cross-member pair by joints, each joint is operatively connected to one of the tower members; and,
a cargo area connected to the frame.

2. The folding wagon of claim 1, wherein the joints comprise slider joints that are slidable along the tower members when the frame is moved between an expanded position and a collapsed position.

3. The folding wagon of claim 1, wherein the joints comprise at least four slider joints, each upwardly extending end of the front and rear cross-members are operatively connected to a slider joint,
the upwardly extending ends of the side cross-members adjacent to the front and rear cross-members pairs are operatively connected to a slider joint;
the slider joints are slidable along the tower members when the frame is moved between an expanded position and a collapsed position.

4. The folding wagon of claim 1, wherein the at least two cross-members of the cross-member pairs are connected side-by-side at the intermediate pivot location.

5. The folding wagon of claim 1, comprising a plurality of wheels, at least one wheel rotatably connected to a lower portion of each tower member.

6. The folding wagon of claim 1, wherein the cargo area has an open top and a bottom, the bottom having four corners,
the top is connected to an upper portion of the four tower members and each bottom corner is slidably connected to the one of the tower members.

7. The folding wagon of claim 1, wherein the cargo area has an open top and a bottom, the bottom having four corners,
the top is connected to an upper portion of the four tower members and each bottom corner is slidably connected to the one of the tower members;
and wherein the joints including at least four slider joints, each upwardly extending end of the front and rear cross-members are operatively connected to a slider joint,
the upwardly extending ends of the side cross-members adjacent to the front and rear cross-members pairs are operatively connected to a slider joint;
the slider joints are slidable along the tower members when the frame is moved between an expanded position and a collapsed position;
the slider joint is positioned to support the bottom corner of the cargo area.

8. The folding wagon of claim 1, wherein the side cross-member pairs of each opposite side each comprises a first side cross-member pair and a second side cross-member pair;
the first side cross-member pair is hinged end-to-end by upper and lower middle joints to the second side cross-member pair, the first side cross-member pair is adjacent to a first end of the frame and the second side cross-member pair is adjacent to a second end of the frame.

9. The folding wagon of claim 8, wherein the upper middle joints are positioned to support the cargo area when the wagon is in the expanded position.

10. The folding wagon of claim 1, comprising two side tower members; and
wherein the side cross-member pairs of each opposite sides each comprises a first side cross-member pair and a second side cross-member pair;
the first side cross-member pair is hinged end-to-end by upper middle slider joint and a lower middle joint to the second side cross-member pair, the first side cross-member pair is adjacent to a first end of the frame and the second side cross-member pair is adjacent to a second end of the frame;
each upper and lower middle joint is connected one of the side tower members;
the upper sliding middle joints are slidable along the side tower members when the frame is moved between an expanded position and a collapsed position; and
the cargo area is connected to the side tower members.

11. The folding wagon of claim 1, wherein at least one cross-member of at least one of the cross-member pairs is straight and the other cross-member of the cross-member pair has opposite ends that are offset in the same direction outwardly from an intermediate portion of the cross-member.

12. The folding wagon of claim 1, wherein each of the opposite side comprises two cross-member pairs connected end-to-end, and wherein the intermediate pivot location of each of the cross-member pairs is offset from the midpoint of each cross-member of the cross-member pair.

13. The folding wagon of claim 1, comprising a collapsible handle connected to the frame, where the handle comprises at least one telescoping member that slides within a larger telescoping member to collapse or extend the handle.

14. A folding wagon, comprising:
a collapsible frame having an expanded position and a collapsed position, the frame expands in at least two directions when moving from collapsed position to an expanded position;
the frame being defined by a front cross-member pair, a back cross-member pair, at least two side cross-member pairs, and at least four tower members;
the front, back, and side cross-member pairs having two cross-members pivotally connected at an intermediate pivot point along each cross-member of the pair;
at least one cross-member of each of the front and rear cross-member pairs being connected at joints to each of the side cross-member pairs in a pivotally displaceable manner about at least two axes; each joint being connected to one of the tower members;
the cross-members pairs are collapsible about their respective intermediate pivot points to move the frame between the expanded position and the collapsed position;
a basket connected to each of the tower members forming a cargo area;
a plurality of wheels, at least one wheel rotatably connected to a lower portion of each tower member.

15. A folding wagon of claim 14, wherein each joint connects the tower member between the ends of the cross-members being connected by the joint.

16. A folding wagon of claim 14, wherein at least two joints are contacted to each tower member;
the upper joint is a slider joint that is slidable along the tower member when the frame is moved between an expanded position and a collapsed position,
the lower joint is a fixed joint that is stationary relative to the tower member in the vertical direction.

17. A folding wagon of claim 14, wherein the basket has an open top and a bottom, the bottom having four corners,
the top is connected to an upper portion of the four tower members, and each bottom corner is slidably connected to the one of the tower members above the joints.

18. The folding wagon of claim 14, comprising two side tower members; and
wherein the side cross-member pairs of each opposite sides each comprises a first side cross-member pair and a second side cross-member pair;
the first side cross-member pair is hinged end-to-end by upper middle slider joint and a lower middle joint to the second side cross-member pair, the first side cross-member pair is adjacent to a first end of the frame and the second side cross-member pair is adjacent to a second end of the frame;
each upper and lower middle joint is connected one of the side tower members;
the upper sliding middle joints are slidable along the side tower members when the frame is moved between an expanded position and a collapsed position; and
the basket is connected to the side tower members.

19. The folding wagon of claim 14, wherein each of the joints is disposed substantially equidistant from the intermediate pivot adjacent thereto.

20. A folding wagon, comprising:
a collapsible frame having a front end and a back end and two opposite sides, four corners; the front end, the back end, and the two opposite sides have at least one cross-member pair;
the cross-member pairs have at least two cross-members connected at an intermediate pivot location; the cross-members are pivotable about the intermediate pivot location to move the frame between an expanded position and a collapsed position;
ends of the cross-members pairs at each corner are connected transversely to an adjacent cross-member pair by joints; and,
a cargo area having an open top and a bottom floor, the bottom floor having at least four corners, and each bottom corner is connected to the frame.
